(19) United States
(12) Patent Application Publication
(10) Pub. No.: US 2015/0043599 A1
(43) Pub. Date: Feb. 12, 2015

(54) LASER SYSTEM AND EXTREME ULTRAVIOLET LIGHT GENERATION SYSTEM

(71) Applicant: GIGAPHOTON INC., Oyama-shi (JP)

(72) Inventors: Tatsuya YANAGIDA, Oyama-shi (JP); Osamu WAKABAYASHI, Oyama-shi (JP)

(21) Appl. No.: 14/523,750

(22) Filed: Oct. 24, 2014

Related U.S. Application Data
(63) Continuation of application No. PCT/JP2013/061783, filed on Apr. 22, 2013.

(30) Foreign Application Priority Data
Apr. 27, 2012 (JP) 2012-103580

(51) Int. Cl. H01S 3/11

(52) U.S. Cl. CPC H01S 3/1106
USPC 372/18

(57) ABSTRACT

The laser system may include: a clock generator; a mode-locked laser device having an optical resonator; a controlling device capable of controlling resonator length of the optical resonator; a detector disposed in an optical path of the pulse laser beam, configured to detect the pulse laser beam and output a detection signal; a switching device disposed in the optical path of the pulse laser beam, capable of switching the pulse laser beam; and a controller, capable of controlling the controlling device based on the clock signal outputted by the clock generator and on the detection signal outputted by the detector, and capable of controlling the switching device based on the clock signal outputted by the clock generator and on a timing signal outputted by an external device.

### TECHNICAL FIELD

The present disclosure relates to a laser system and an extreme ultraviolet light generation system.

### BACKGROUND ART

In recent years, as semiconductor processes become finer, transfer patterns for use in photolithographies of semiconductor processes have rapidly become finer. In the next generation, microfabrication at 70 nm to 45 nm, further, microfabrication at 32 nm or less would be demanded. In order to meet the demand for microfabrication at 32 nm or less, for example, it is expected to develop an exposure apparatus in which a system for generating EUV light at a wavelength of approximately 13 nm is combined with a reduced projection reflective optical system.

Three types of EUV light generation systems have been proposed, which include an LPP (laser produced plasma) type system using plasma generated by irradiating a target with a laser beam, a DPP (discharge produced plasma) type system using plasma generated by electric discharge, and an SR (synchrotron radiation) type system using orbital radiation.

### SUMMARY

A laser system according to one aspect of the present disclosure may include: a clock generator configured to output a clock signal; a mode-locked laser device having an optical resonator and configured to oscillate at a plurality of longitudinal modes with fixed phases with each other to output a pulse laser beam; a controlling device capable of controlling resonator length of the optical resonator; a detector disposed in an optical path of the pulse laser beam, configured to detect the pulse laser beam and output a detection signal; a switching device disposed in the optical path of the pulse laser beam, capable of switching the pulse laser beam; and a controller, capable of controlling the controlling device based on the clock signal outputted by the clock generator and on the detection signal outputted by the detector, and capable of controlling the switching device based on the clock signal outputted by the clock generator and on a timing signal outputted by an external device.

An extreme ultraviolet light generation system according to another aspect of the present disclosure may include: a clock generator configured to output a clock signal; a mode-locked laser device having an optical resonator and configured to oscillate at a plurality of longitudinal modes with fixed phases with each other to output a pulse laser beam; a controlling device capable of controlling resonator length of the optical resonator; a detector disposed in an optical path of the pulse laser beam, configured to detect the pulse laser beam and output a detection signal; a switching device disposed in the optical path of the pulse laser beam, capable of switching the pulse laser beam; a chamber disposed in downstream of the switching device in the optical path of the pulse laser beam, and having an entrance at a position where the pulse laser beam can enter into the chamber; a target supply device disposed with the chamber, capable of supplying a target material to a predetermined region in the chamber, and capable of outputting a timing signal showing supply timing of the target material; a laser beam focusing optics disposed between the switching device and the predetermined region in the optical path of the pulse laser beam, capable of focusing the pulse laser beam at the predetermined region; and a controller, capable of controlling the controlling device based on the clock signal outputted by the clock generator and on the detection signal outputted by the detector, and capable of controlling the switching device based on the clock signal outputted by the clock generator and on the timing signal outputted by the target supply device.

A laser system according to another aspect of the present disclosure may include: a clock generator configured to output a clock signal; a frequency divider configured to output, based on the clock signal outputted by the clock generator, a timing signal having repetition rate which is lower than repetition rate of the clock signal; a mode-locked laser device having an optical resonator and configured to oscillate at a plurality of longitudinal modes with fixed phases with each other to output a pulse laser beam; a controlling device capable of controlling resonator length of the optical resonator; a detector disposed in an optical path of the pulse laser beam, configured to detect the pulse laser beam and output a detection signal; a switching device disposed in the optical path of the pulse laser beam, capable of switching the pulse laser beam; and a controller, capable of controlling the controlling device based on the clock signal outputted by the clock generator and on the detection signal outputted by the detector, and capable of controlling the switching device based on the timing signal outputted by the frequency divider.

An extreme ultraviolet light generation system according to another aspect of the present disclosure may include: a clock generator configured to output a clock signal; a frequency divider configured to output, based on the clock signal outputted by the clock generator, a timing signal having repetition rate which is lower than repetition rate of the clock signal; a mode-locked laser device having an optical resonator and configured to oscillate at a plurality of longitudinal modes with fixed phases with each other to output a pulse laser beam; a controlling device capable of controlling resonator length of the optical resonator; a detector disposed in an optical path of the pulse laser beam, configured to detect the pulse laser beam and output a detection signal; a switching device disposed in the optical path of the pulse laser beam, capable of switching the pulse laser beam; a chamber disposed in downstream of the switching device in the optical path of the pulse laser beam, and having an entrance at a position where the pulse laser beam can enter into the chamber; a target supply device disposed with the chamber, capable of supplying a target material to a predetermined region in the chamber based on the timing signal outputted by the frequency divider; a laser beam focusing optics disposed between the switching device and the predetermined region in the optical path of the pulse laser beam, capable of focusing the pulse laser beam at the predetermined region; and a controller, capable of controlling the controlling device based on the clock signal outputted by the clock generator and on the detection signal outputted by the detector, and capable of controlling the switching device based on the timing signal outputted by the frequency divider.

### BRIEF DESCRIPTION OF THE DRAWINGS

Hereinafter, selected embodiments of the present disclosure will be described with reference to the accompanying drawings by way of example.

FIG. 1 schematically illustrates a configuration example of an LPP type EUV light generation system.

FIG. 2 is a partial cross-sectional view schematically showing a configuration example of the EUV light generation system according to a first embodiment.

FIG. 3 schematically illustrates a configuration example of a pre-pulse laser apparatus shown in FIG. 2.

FIG. 4 schematically illustrates a configuration example of a mode-locked laser device shown in FIG. 3.

FIG. 5 schematically illustrates a configuration example of a regenerative amplifier shown in FIG. 3.

FIG. 6 schematically illustrates a beam path in the regenerative amplifier shown in FIG. 5 when voltage is applied to the Pockels cell.

FIGS. 7A through 7E are timing charts of various signals in the pre-pulse laser apparatus shown in FIG. 3.

FIG. 8 schematically illustrates a configuration example of a main pulse laser apparatus in the first embodiment.

FIG. 9 is a partial cross-sectional view schematically showing a configuration example of the EUV light generation system according to a second embodiment.

FIG. 10 schematically illustrates a configuration example of a pre-pulse laser apparatus in the second embodiment.

FIG. 11 schematically illustrates a configuration example of the pre-pulse laser apparatus according to a third embodiment.

FIG. 12 schematically illustrates a configuration example of the pre-pulse laser apparatus according to a fourth embodiment.

FIG. 13 schematically illustrates a configuration example of the pre-pulse laser apparatus according to a fifth embodiment.

FIG. 14 is a graph showing a relationship between an irradiation condition of the pre-pulse laser beam and CE in the EUV light generation system.

FIG. 15A is a graph showing a relationship between fluence of the pre-pulse laser beam and CE in the EUV light generation system. FIG. 15B is a graph showing a relationship between light intensity of the pre-pulse laser beam and CE in the EUV light generation system.

FIGS. 16A and 16B show photographs of a diffused target after the droplet target is irradiated with the pre-pulse laser beam in the EUV light generation system.

FIG. 17 schematically illustrates an arrangement of equipment used to capture the photographs shown in FIGS. 16A and 16B.

FIGS. 18A and 18B are sectional views schematically illustrating the diffused targets respectively shown in FIGS. 16A and 16B.

FIG. 19A schematically illustrates a configuration example of the main pulse laser apparatus according to a sixth embodiment. FIG. 19B is a graph showing a pulse waveform of the pulse laser beam outputted from a master oscillator MO. FIG. 19C is a graph showing a pulse waveform of the pulse laser beam outputted from a waveform controller. FIG. 19D is a graph showing a pulse waveform of the pulse laser beam outputted from an amplifier PA3.

FIG. 20A shows a schematic configuration example of the waveform controller shown in FIG. 19A. FIG. 20B is a graph showing a pulse waveform of the pulse laser beam inputted to the waveform controller. FIG. 20C is a graph showing a waveform of pulse voltage outputted from a high voltage power supply. FIG. 20D is a graph showing a pulse waveform of the pulse laser beam outputted from the waveform controller.

FIG. 21 schematically shows a configuration example of the main pulse laser apparatus according to a seventh embodiment.

FIG. 22A schematically illustrates a configuration example of the main pulse laser apparatus according to an eighth embodiment. FIG. 22B is a graph showing a pulse waveform of the pulse laser beam outputted from a second master oscillator. FIG. 22C is a graph showing a pulse waveform of the pulse laser beam outputted from a first master oscillator. FIG. 22D is a graph showing a pulse waveform of the pulse laser beam outputted from an optical path controller. FIG. 22E is a graph showing a pulse waveform of the pulse laser beam outputted from the main pulse laser apparatus.

FIG. 23A schematically illustrates a configuration example of the main pulse laser apparatus according to a ninth embodiment. FIG. 23B is a graph showing a pulse waveform of the pulse laser beam outputted from the second master oscillator. FIG. 23C is a graph showing a pulse waveform of the pulse laser beam outputted from the first master oscillator. FIG. 23D is a graph showing a pulse waveform of the pulse laser beam outputted from the optical path controller. FIG. 23E is a graph showing a pulse waveform of the pulse laser beam outputted from the main pulse laser apparatus.

FIG. 24 is a partial cross-sectional view schematically showing a configuration example of the EUV light generation system according to a tenth embodiment.

FIG. 25 schematically illustrates a configuration example of a beam shaping optical system shown in FIG. 24.

FIG. 26 schematically illustrates another configuration example of the beam shaping optical system shown in FIG. 24.

FIG. 27 schematically illustrates another configuration example of the beam shaping optical system shown in FIG. 24.

### EMBODIMENTS

### Contents

### 1. Overview

2. Description of terms
3. Overview of the EUV light generation system

3.1 Configuration

3.2 Operation

4. Extreme ultraviolet light generation system including a pre-pulse laser apparatus

4.1 Configuration

4.2 Operation

5. Pre-pulse laser apparatus

5.1 General configuration

5.2 Mode-locked laser device

5.3 Regenerative amplifier
5.3.1 When voltage is not applied to the Pockels cell
5.3.2 When voltage is applied to the Pockels cell

5.4 Timing control

6. Main pulse laser apparatus

### 7. Others

7.1 Variation of the timing signal

7.2 Variation of the pre-pulse laser apparatus (1)

7.3 Variation of the pre-pulse laser apparatus (2)

7.4 Variation of the pre-pulse laser apparatus (3)

7.5 Pulse duration of the pre-pulse laser beam

7.6 Variation of the main pulse laser apparatus (1)

7.7 Variation of the main pulse laser apparatus (2)

7.8 Variation of the main pulse laser apparatus (3)

7.9 Variation of the main pulse laser apparatus (4)

7.10 Light intensity distribution of the main pulse laser beam

Hereinafter, selected embodiments of the present disclosure will be described in detail with reference to the accompanying drawings. The embodiments to be described below are merely illustrative in nature and do not limit the scope of the present disclosure. Further, the configuration(s) and operation(s) described in each embodiment are not all essential in implementing the present disclosure. Corresponding elements may be referenced by corresponding reference numerals and characters, and duplicate descriptions thereof may be omitted.

### 1. Overview

In an LPP type EUV light generation apparatus, a droplet target may be outputted into a chamber, and a pulse laser beam outputted from a laser system may be focused on the droplet target, whereby the target material in the droplet target may be turned into plasma. Rays of light including EUV light may be emitted from the plasma. The emitted EUV light may be collected by an EUV collector mirror disposed within the chamber and may be outputted to exposure apparatus or the like.

In the LPP type EUV light generation apparatus, the droplet target may be diffused by being irradiated with a pre-pulse laser beam, thereby forming a diffused target, and then, the diffused target may be irradiated with a main pulse laser beam. By irradiating the diffused target with the main pulse laser beam, the target material can be turned into plasma efficiently. According to this, conversion efficiency (CE) from energy of the pulse laser beam to energy of the EUV light can be improved. The inventors discovered that the pre-pulse laser beam to diffuse the droplet target might preferably have short pulse duration of several tens of picoseconds or less.

A mode-locked laser device may be used to generate a pulse laser beam having the short pulse duration. The mode-locked laser device may oscillate at a plurality of longitudinal modes with fixed phases with each other. When the plurality of longitudinal modes is combined with each other, a pulse laser beam having short pulse duration may be outputted. However, timing at which a pulse of the pulse laser beam is outputted from the mode-locked laser device may depend on timing at which a preceding pulse is outputted and depend on repetition rate in accordance with resonator length of the mode-locked laser device. Accordingly, it may not be easy to control the mode-locked laser device such that each pulse is outputted at desired timing. Therefore, it may be difficult to irradiate the droplet target, which is supplied into the chamber, with the pre-pulse laser beam. Here, the repetition rate may be the number of oscillating pulses per second.

In one aspect of the present disclosure, a laser system may include a clock generator. The resonator length of the mode-locked laser device may be adjusted such that the mode-locked laser device may be synchronized with the clock signal outputted by the clock generator. Based on the clock signal outputted by the clock generator and on a timing signal outputted by a target supply device, it may be possible to switch pulses of a pulse laser beam outputted from the mode-locked laser device. The repetition rate of the pulse laser beam outputted from the mode-locked laser device may be, for example, around 100 MHz, which may be higher than the repetition rate of the timing signal. The timing signal may be a signal representing timing at which a predetermined delay time has passed from timing at which the target supply device supplied the target. The repetition rate of the timing signal may be, for example, around 100 kHz.

According to this configuration, since the pulse laser beam is switched according to the timing signal, it may be possible to synchronize timing of the pulse laser beam arriving at a predetermined region with timing of the target arriving at the same region. Also, since the mode-locked laser device is synchronized with the clock signal and the pulse laser beam is switched based on the clock signal, only a desired pulse may be selected from among the pulses to hit the target. The desired pulse may be a single pulse.

### 2. Description of Terms

“Pulse laser beam” may refer to a laser beam including a plurality of pulses.

“Laser beam” may generally refer to a laser beam not being limited to the pulse laser beam.

“Target material” may refer to a material, such as tin, gadolinium, terbium and the like, that may turn into plasma by being irradiated with the pulse laser beam to emit EUV light from the plasma.

“Target” may refer to a mass, containing a minutely small amount of the target material, which is supplied into the chamber by the target supply device and irradiated with the pulse laser beam. In particular, the term “droplet target” may refer to a target containing a minutely small amount of molten target material which has been released within the chamber to be a substantially spherical shape by the surface tension of the target material.

“Diffused target” may refer to a target diffused by irradiation with the pre-pulse laser beam. By irradiating the diffused target with the main pulse laser beam, the target material may efficiently turn into plasma.

### 3. Overview of the EUV Light Generation System

3.1 Configuration

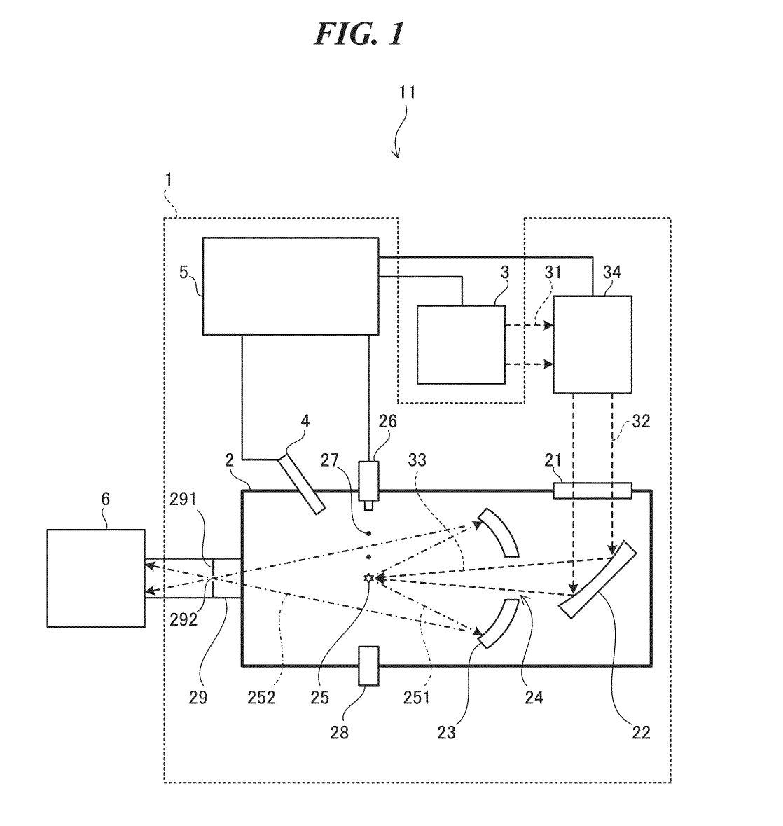

FIG. 1 schematically illustrates a configuration example of an LPP type EUV light generation system 11. An EUV light generation apparatus 1 may be used with at least one laser system 3. Hereinafter, a system that includes the EUV light generation apparatus 1 and the laser system 3 may be referred to as an EUV light generation system 11. As shown in FIG. 1 and described in detail below, the EUV light generation system 11 may include a chamber 2 and a target supply device 26. The chamber 2 may be sealed airtight. The target supply device 26 may be mounted onto the chamber 2, for example, to penetrate a wall of the chamber 2. A target material to be supplied by the target supply device 26 may include, but is not limited to, tin, terbium, gadolinium, lithium, xenon, or a combination of any two or more of them.

The chamber 2 may have at least one through-hole in its wall. A window 21 may be located at the through-hole. A pulse laser beam 32 may travel through the window 21. In the chamber 2, an EUV collector mirror 23 having a spheroidal reflective surface may be provided. The EUV collector mirror 23 may have a first focusing point and a second focusing point. The reflective surface of the EUV collector mirror 23 may have a multi-layered reflective film in which molybdenum layers and silicon layers are alternately laminated. The EUV collector mirror 23 may be arranged such that the first focusing point is positioned in a plasma generation region 25 and the second focusing point is positioned in an intermediate focus (IF) region 292. The EUV collector mirror 23 may have a through-hole 24 formed at the center thereof so that a pulse laser beam 33 may travel through the through-hole 24.

The EUV light generation apparatus 1 may further include an EUV light generation controller 5 and a target sensor 4. The target sensor 4 may have an imaging function and detect at least one of the presence, trajectory, position and speed of a target 27.

Further, the EUV light generation apparatus 1 may include a connection part 29 for allowing the interior of the chamber 2 to be in communication with the interior of the exposure apparatus 6. In the connection part 29, a wall 291 having an aperture may be provided. The wall 291 may be positioned such that the second focusing point of the EUV collector mirror 23 lies in the aperture formed in the wall 291.

The EUV light generation apparatus 1 may also include a laser beam direction control unit 34, a laser beam focusing mirror 22, and a target collector 28 for collecting the target 27. The laser beam direction control unit 34 may include an optical element (not separately shown) for defining the direction of the pulse laser beam and an actuator (not separately shown) for adjusting the position or the posture of the optical element.

3.2 Operation

With continued reference to FIG. 1, a pulse laser beam 31 outputted from the laser system 3 may pass through the laser beam direction control unit 34 and be outputted therefrom as the pulse laser beam 32 to travel through the window 21 and enter into the chamber 2. The pulse laser beam 32 may travel inside the chamber 2 along at least one beam path, be reflected by the laser beam focusing mirror 22, and strike at least one target 27 as a pulse laser beam 33.

The target supply device 26 may be configured to output the target(s) 27 toward the plasma generation region 25 in the chamber 2. The target 27 may be irradiated with at least one pulse of the pulse laser beam 33. Upon being irradiated with the pulse laser beam 33, the target 27 may be turned into plasma, and rays of light 251 may be emitted from the plasma. At least EUV light included in the light 251 may be reflected selectively by the EUV collector mirror 23. The EUV light 252 reflected by the EUV collector mirror 23 may travel through the intermediate focus region 292 and be outputted to the exposure apparatus 6. Alternatively, the target 27 may be irradiated with multiple pulses included in the pulse laser beam 33.

The EUV light generation controller 5 may be configured to integrally control the EUV light generation system 11. The EUV light generation controller 5 may be configured to process image data of the target 27 captured by the target sensor 4. Further, the EUV light generation controller 5 may be configured to control at least one of: the timing when the target 27 is outputted; and the direction to which the target 27 is outputted. Furthermore, the EUV light generation controller 5 may be configured to control at least one of: the timing when the laser system 3 oscillates; the direction in which the pulse laser beam 33 travels; and the position at which the pulse laser beam 33 is focused. The various controls mentioned above are merely examples, and other controls may be added as necessary.

### 4. Extreme Ultraviolet Light Generation System Including a Pre-Pulse Laser Apparatus

4.1 Configuration

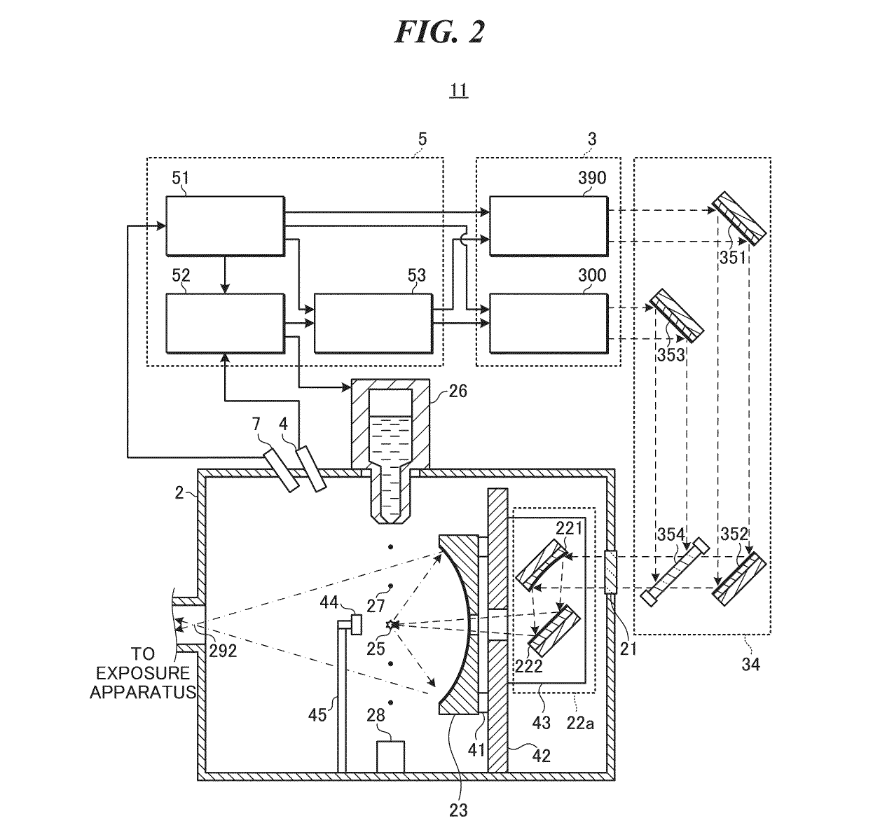

FIG. 2 is a partial cross-sectional view schematically showing a configuration example of the EUV light generation system 11 according to a first embodiment. As shown in FIG. 2, a laser beam focusing optics 22a, the EUV collector mirror 23, a target collector 28, an EUV collector mirror holder 41, plates 43 and 42, a beam dump 44, and beam dump support member 45 may be provided inside the chamber 2.

The plate 42 may be fixed to the chamber 2, and the plate 43 may be fixed to the plate 42. The EUV collector mirror 23 may be fixed to the plate 42 via the EUV collector mirror holder 41.

The laser beam focusing optics 22a may include an off-axis paraboloidal mirror 221, a flat mirror 222, and holders respectively holding these mirrors. The flat mirror 222 and the off-axis paraboloidal mirror 221 may be fixed via the respective holders to the plate 43 so that the pulse laser beam reflected by these mirrors is focused on the plasma generation region 25.

The beam dump 44 may be fixed via the beam dump support member 45 to the chamber 2 so that the beam dump 44 is positioned on the extension line of the optical path of the pulse laser beam. The target collector 28 may be disposed on the extension line of the trajectory of the target 27.

The target sensor 4, the EUV light sensor 7, the window 21, and the target supply device 26 may be attached to the chamber 2. The laser beam direction control unit 34 and the EUV light generation controller 5 may be arranged outside the chamber 2.

The EUV light sensor 7 may detect light intensity of the EUV light generated in the plasma generation region 25 and output a detection signal to an EUV controller 51. The target supply device 26 may be a device which continues to output targets at regular intervals. Alternatively, the target supply device 26 may be a device which outputs each target on demand at timing corresponding to a trigger signal received from a target controller 52. The laser beam direction control unit 34 may include high reflection mirrors 351, 352 and 353, a dichroic mirror 354, and holders respectively holding these mirrors.

The EUV light generation controller 5 may include the EUV controller 51, the target controller 52 and a delay circuit 53. The EUV controller 51 may output a control signal to the target controller 52, the delay circuit 53 and the laser system 3.

The laser system 3 contained in the EUV light generation system 11 may include a pre-pulse laser apparatus 300 for outputting the pre-pulse laser beam, and a main pulse laser apparatus 390 for outputting the main pulse laser beam. The dichroic mirror 354 mentioned above may have a coating to reflect wavelength components contained in the pre-pulse laser beam at high reflectance, and to transmit wavelength components contained in the main pulse laser beam at high transmittance, so that the dichroic mirror 354 functions as a beam combiner.

4.2 Operation

The target controller 52 may output a target supply start signal to the target supply device 26 so that the target supply device 26 starts supplying the target 27 to the plasma generation region 25 in the chamber 2.

The target supply device 26 may output the droplet target 27 to the plasma generation region 25 in response to receiving the target supply start signal from the target controller 52. The target controller 52 may receive a target detection signal from the target sensor 4 and output the target detection signal to the delay circuit 53. The target sensor 4 may detect timing when the target 27 passes through a predetermined position before reaching the plasma generation region 25. For example, the target sensor 4 may include an illumination device and an optical sensor (not shown). The illumination device may be a laser apparatus that may be arranged so as to output a CW laser beam toward the predetermined position. When the target 27 reaches the predetermined position, the target 27 may reflect the CW laser beam. The optical sensor may be positioned to detect reflected light reflected by the target 27. If the target passed through the predetermined position before reaching the plasma generation region, the optical sensor may detect passage timing of the target 27 by detecting the reflected light reflected by the target 27, and output a target detection signal.

The delay circuit 53 may output a timing signal which represents timing at which a predetermined delay time has passed from the timing of the target detection signal. The delay circuit 53 may output a first timing signal to the pre-pulse laser apparatus 300 so that the pre-pulse laser beam reaches the plasma generation region 25 at the timing when the target 27 reaches the plasma generation region 25. The delay circuit 53 may output a second timing signal to the main pulse laser apparatus 390 so that the main pulse laser beam reaches the plasma generation region 25 at timing when the target irradiated with the pre-pulse laser beam is diffused to a predetermined diffusion diameter.

The pre-pulse laser apparatus 300 may output the pre-pulse laser beam in response to the first timing signal from the delay circuit 53. The main pulse laser apparatus 390 may output the main pulse laser beam in response to the second timing signal from the delay circuit 53.

The pre-pulse laser beam outputted from the pre-pulse laser apparatus 300 may be reflected by the high reflection mirror 353 and the dichroic mirror 354, and enter into the laser beam focusing optics 22a through the window 21. The main pulse laser beam outputted from the main pulse laser apparatus 390 may be reflected by the high reflection mirrors 351 and 352, transmitted through the dichroic mirror 354, and enter into the laser beam focusing optics 22a through the window 21.

The pre-pulse laser beam and the main pulse laser beam entered into the laser beam focusing optics 22a may be reflected by the off-axis paraboloidal mirror 221 and the flat mirror 222, and be directed to the plasma generation region 25. The target 27 irradiated with the pre-pulse laser beam may be diffused to become a diffused target. The diffused target may be irradiated with the main pulse laser beam to be turned into plasma.

### 5. Pre-Pulse Laser Apparatus

5.1 General Configuration

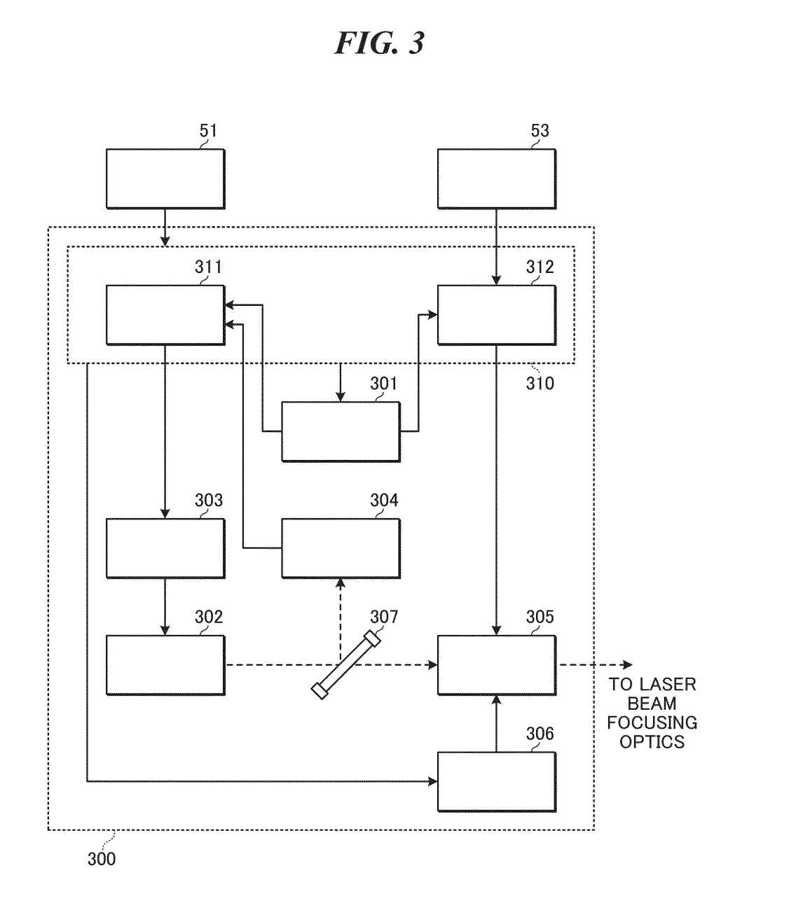

FIG. 3 schematically illustrates a configuration example of the pre-pulse laser apparatus 300 shown in FIG. 2. The pre-pulse laser apparatus 300 may include a clock generator 301, a mode-locked laser device 302, a resonator length controlling driver 303, a pulse laser beam detector 304, a regenerative amplifier 305, an excitation power supply 306, and a controller 310.

The clock generator 301 may output a clock signal, for example, at a repetition rate of 100 MHz. The mode-locked laser device 302 may oscillate at a plurality of longitudinal modes with fixed phases with each other. The mode-locked laser device 302 may output a pulse laser beam at a repetition rate of approximately 100 MHz, for example. The mode-locked laser device 302 may include an optical resonator which will be described later. The resonator length of the optical resonator may be adjusted through the resonator length controlling driver 303.

A beam splitter 307 may be provided in a beam path of the pulse laser beam outputted by the mode-locked laser device 302. The pulse laser beam detector 304 may be provided in one of beam paths of the pulse laser beam split by the beam splitter 307. The pulse laser beam detector 304 may be configured to detect the pulse laser beam and output a detection signal.

The regenerative amplifier 305 may be provided in the other of the beam paths of the pulse laser beam split by the beam splitter 307. The regenerative amplifier 305 may include an optical resonator in which the pulse laser beam is amplified by traveling back and forth several times. The regenerative amplifier 305 may take out the amplified pulse laser beam at timing when the pulse laser beam has traveled a predetermined number of times in the optical resonator. In the optical resonator of the regenerative amplifier 305, a laser medium (described later) may be disposed. Energy for exciting the laser medium may be provided via the excitation power supply 306 to the laser medium. The regenerative amplifier 305 may include a Pockels cell (described later) therein.

The controller 310 may include a phase adjuster 311 and an AND circuit 312. The phase adjuster 311 may carry out feedback-control on the resonator length controlling driver 303 based on the clock signal from the clock generator 301 and the detection signal from the pulse laser beam detector 304.

Further, the controller 310 may control the regenerative amplifier 305 based on the clock signal from the clock generator 301 and the aforementioned timing signal from the delay circuit 53. The timing signal from the delay circuit 53 may be the first timing signal mentioned above. The AND circuit 312 may generate an AND signal of the clock signal and the timing signal, and control a Pockels cell inside the regenerative amplifier 305 based on the AND signal.

5.2 Mode-Locked Laser Device

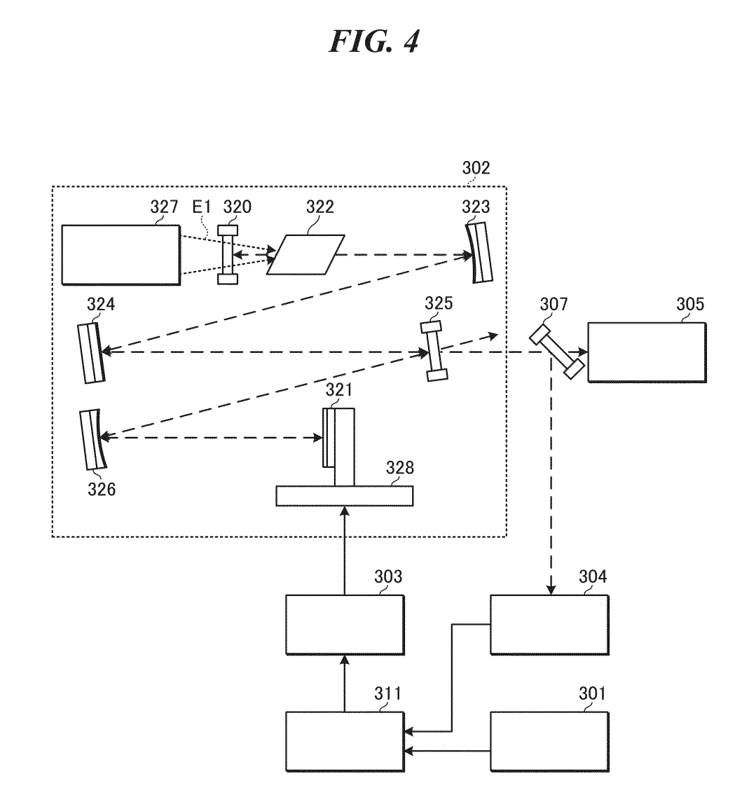

FIG. 4 schematically illustrates a configuration example of the mode-locked laser device shown in FIG. 3. The mode-locked laser device 302 may include an optical resonator formed by a flat mirror 320 and a saturable absorber mirror 321. In the optical resonator, a laser crystal 322, a concave mirror 323, a flat mirror 324, an output coupler mirror 325, and a concave mirror 326 may be provided in this order from the side of the flat mirror 320. The beam path in the optical resonator may be substantially parallel to the paper plane. The mode-locked laser device 302 may further include an excitation light source 327 configured to generate excitation light E1 to the laser crystal 322 from the outside of the optical resonator. The excitation light source 327 may include a laser diode to generate the excitation light E1.

The flat mirror 320 may be configured to transmit wavelength components of the excitation light E1 from the excitation light source 327 with high transmittance and reflect wavelength components of emitted light from the laser crystal 322 with high reflectance. The laser crystal 322 may be a laser medium that undergoes stimulated emission with the excitation light E1. The laser crystal 322 may, for example, be a neodymium-doped yttrium orthovanadate (Nd:YVO₄) crystal. Light emitted from the laser crystal 322 may include a plurality of longitudinal modes (frequency components). The laser crystal 322 may be arranged such that a laser beam is incident on the laser crystal 322 at a Brewster's angle.

The concave mirror 323, the flat mirror 324, and the concave mirror 326 may reflect the light emitted from the laser crystal 322 with high reflectance. The output coupler mirror 325 may be configured to transmit a part of the laser beam amplified in the optical resonator to the outside of the optical resonator and reflect the remaining part of the laser beam to be further amplified in the optical resonator. First and second laser beams that travel in different directions may be outputted through the output coupler mirror 325 to the outside of the optical resonator. The first laser beam includes a part of the light reflected by the flat mirror 324 and transmitted through the output coupler mirror 325. The second laser beam includes a part of the light reflected by the concave mirror 326 and transmitted through the output coupler mirror 325. The aforementioned beam splitter 307 may be provided in a beam path of the first laser beam. A beam dump (not shown) may be provided in a beam path of the second laser beam.

The saturable absorber mirror 321 may be formed such that a reflective layer is laminated on a mirror substrate and a saturable absorber layer is laminated on the reflective layer. In the saturable absorber mirror 321, the saturable absorber layer may absorb incident light while light intensity thereof is lower than a predetermined threshold value. When the light intensity of the incident light increases up to the threshold value or more, the saturable absorber layer may transmit the incident light and the reflective layer may reflect the incident light. With this configuration, only high intensity pulses of the laser beam may be reflected by the saturable absorber mirror 321. The high intensity pulses may be instantaneously generated when phases of the plurality of longitudinal modes match with each other.

In this way, pulses of the laser beam in which phases of the plurality of longitudinal modes are fixed with each other may travel back and forth in the optical resonator and such pulses may be amplified. This situation may be referred to as mode-lock. The amplified pulses may be periodically outputted through the output coupler mirror 325 as a pulse laser beam. The repetition rate of this pulse laser beam may correspond to an inverse of a time period for a pulse to travel once back and forth in the optical resonator. For example, when the resonator length L is 1.5 m and the speed of light c is 3×10⁸ m/s, the repetition rate f may be 100 MHz as calculated by the following equation.

$$\begin{matrix}f = c / ( 2 L ) \\ = ( 3 \times {10}^{8} ) / ( 2 \times 1.5 ) \\ = 100 MHz\end{matrix}$$

Since the laser crystal 322 is arranged as shown in FIG. 4 at the Brewster's angle to the laser beam, the outputted pulse laser beam may be a linearly polarized laser beam in which polarization direction is parallel to the paper plane.

The saturable absorber mirror 321 may be held by a mirror holder, and this mirror holder may be movable by a linear stage 328 in a travelling direction of the laser beam. The travelling direction of the laser beam may be a horizontal direction of FIG. 4. The linear stage 328 may be driven by the resonator length controlling driver 303. As the saturable absorber mirror 321 is moved in the travelling direction of the laser beam, the resonator length may be controlled to adjust the repetition rate of the pulse laser beam.

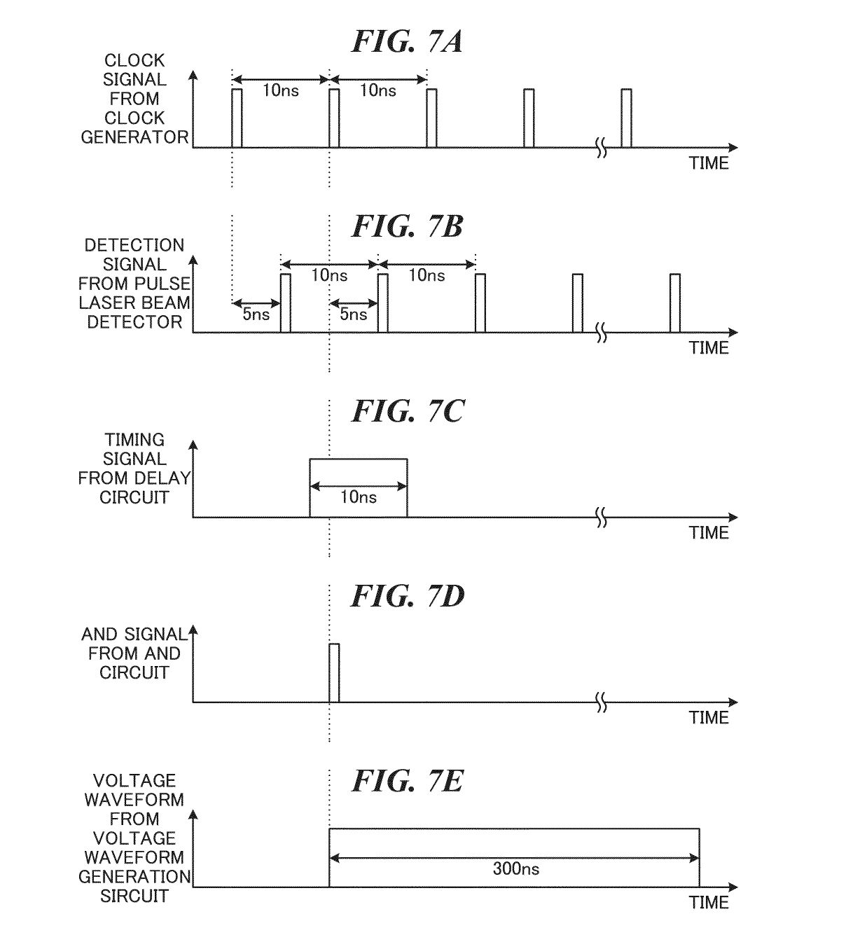

As mentioned above, the phase adjuster 311 may be configured to control the resonator length controlling driver 303 based on the clock signal from the clock generator 301 and on the detection signal from the pulse laser beam detector 304. More specifically, the phase adjuster 311 may detect a phase difference between the clock signal and the detection signal, and control the resonator length controlling driver 303 so that the clock signal and the detection signal are in synchronization at a certain phase difference. The delay time between the clock signal and the detection signal will be explained later with reference to FIGS. 7A and 7B.

5.3 Regenerative Amplifier

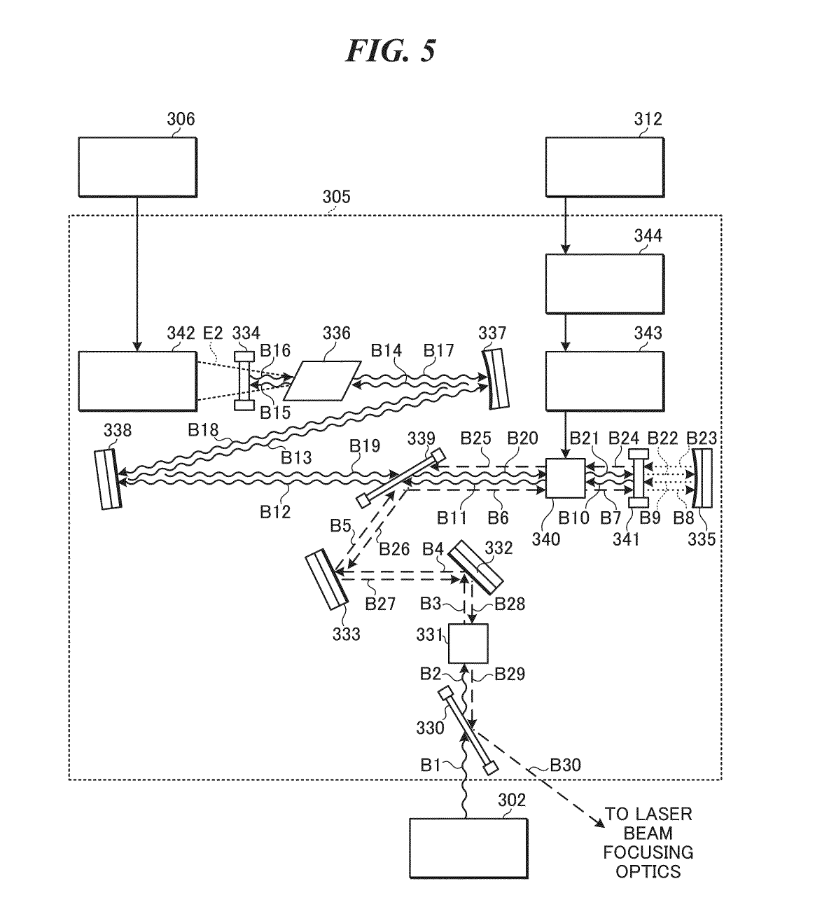

FIG. 5 schematically illustrates a configuration example of the regenerative amplifier shown in FIG. 3. The regenerative amplifier 305 may include an optical resonator formed by a flat mirror 334 and a concave mirror 335. In the optical resonator, a laser crystal 336, a concave mirror 337, a flat mirror 338, a polarization beam splitter 339, a Pockels cell 340, and a quarter wave plate 341 may be provided in this order from the side of the flat mirror 334. The resonator length of the optical resonator in the regenerative amplifier 305 may be shorter than that of the optical resonator in the mode-locked laser device 302. Further, the regenerative amplifier 305 may include an excitation light source 342 configured to introduce excitation light E2 to the laser crystal 336 from the outside of the optical resonator. The excitation light source 342 may include a laser diode to generate the excitation light E2. Further, the regenerative amplifier 305 may include a polarization beam splitter 330, a Faraday optical isolator 331, and flat mirrors 332 and 333. The laser crystal 336 may be arranged such that a laser beam is incident on the laser crystal 336 at a Brewster's angle. The Faraday optical isolator 331 may include a Faraday rotator (not shown) and a half-wave plate (not shown).

The flat mirror 334 may be configured to transmit wavelength components of the excitation light E2 from the excitation light source 342 with high transmittance and reflect wavelength components of emitted light from the laser crystal 336 with high reflectance. The laser crystal 336 may be a laser medium excited by the excitation light E2. The laser crystal 336 may, for example, be a neodymium-doped yttrium aluminum garnet (Nd:YAG) crystal. When a seed beam outputted from the mode-locked laser device 302 is incident on the laser crystal 336 excited by the excitation light E2, the seed beam may be amplified through stimulated emission.

5.3.1 when Voltage is not Applied to the Pockels Cell

The polarization beam splitter 330 may be provided in a beam path of a pulse laser beam B1 from the mode-locked laser device 302. The polarization beam splitter 330 may be arranged such that light receiving surfaces thereof are perpendicular to the paper plane. The polarization beam splitter 330 may be configured to transmit a linearly polarized pulse laser beam B1, polarized in a direction parallel to the paper plane, with high transmittance. As described later, the polarization beam splitter 330 may reflect a linearly polarized pulse laser beam B29 polarized in a direction perpendicular to the paper plane with high reflectance.

The Faraday optical isolator 331 may be provided in a beam path of a pulse laser beam B2 which was transmitted through the polarization beam splitter 330 and came from the lower side in FIG. 5. The Faraday optical isolator 331 may rotate the polarization direction of the linearly polarized pulse laser beam B2, which came from the lower side in FIG. 5, by 90 degrees and output as a pulse laser beam B3. As described later, the Faraday optical isolator 331 may transmit a pulse laser beam B28, which may come from the upper side in FIG. 5, toward the polarization beam splitter 330 without rotating the polarization direction thereof.

The flat mirror 332 may be provided in a beam path of the pulse laser beam B3 transmitted through the Faraday optical isolator 331. The flat mirror 332 may reflect the pulse laser beam B3 with high reflectance. The flat mirror 333 may reflect a pulse laser beam B4 reflected by the flat mirror 332 with high reflectance.

The polarization beam splitter 339 in the optical resonator may be provided in a beam path of a pulse laser beam B5 reflected by the flat mirror 333. The polarization beam splitter 339 may be provided such that the light receiving surfaces thereof are perpendicular to the paper plane. The pulse laser beam B5 may be incident on a right side receiving surface of the polarization beam splitter 339. The polarization beam splitter 339 may reflect the linearly polarized pulse laser beam B5 polarized in a direction perpendicular to the paper plane with high reflectance to thereby guide into the optical resonator as a pulse laser beam B6. As described later, the polarization beam splitter 339 may transmit a linearly polarized pulse laser beam B11 polarized in a direction parallel to the paper plane with high transmittance.

The Pockels cell 340, the quarter wave plate 341 and the concave mirror 335 may be disposed at the right side of the polarization beam splitter 339 in the optical path of the optical resonator. The flat mirror 334, the laser crystal 336, the concave mirror 337 and the flat mirror 338 may be disposed at the left side of the polarization beam splitter 339 in the optical path of the optical resonator.

Voltage may be applied to the Pockels cell 340 by a high voltage power supply 343. When the voltage is not applied to the Pockels cell 340 by the high voltage power supply 343, the Pockels cell 340 may transmit the pulse laser beam B6 to output a pulse laser beam B7 without rotating the polarization direction. The state in which the high voltage power supply 343 does not apply the voltage to the Pockels cell 340 may be referred to as “voltage OFF” and a state in which the high voltage power supply 343 applies the voltage may be referred to as “voltage ON”.

The quarter wave plate 341 may be arranged such that light receiving surfaces thereof are perpendicular to the paper plane. Moreover, the quarter wave plate 341 may be arranged such that the optical axis thereof is tilted, within a plane perpendicular to the incident laser beam, by 45 degrees to the paper plane. The pulse laser beam B7, being incident on the quarter wave plate 341, may have a first polarization component parallel to the optical axis of the quarter wave plate 341, and have a second polarization component perpendicular to both of the optical axis of the quarter wave plate 341 and a traveling direction of the pulse laser beam B7. When the first and second polarization components are combined, the resultant vector may be parallel to the polarization direction of the pulse laser beam B7 and perpendicular to the paper plane.

The quarter wave plate 341 may have a double refraction property to transmit the first and second polarization components through different optical paths. As a result, the quarter wave plate 341 may sift the phase of the second polarization component by ¼ wavelengths with respect to the phase of the first polarization component when the quarter wave plate 341 transmits the pulse laser beam B7. The concave mirror 335 may reflect a pulse laser beam B8 from the quarter wave plate 341 with high reflectance. A pulse laser beam B9 reflected by the concave mirror 335 may be transmitted again through the quarter wave plate 341. Therefore, the quarter wave plate 341 may further shift the phase of the second polarization component by ¼ wavelengths with respect to the phase of the first polarization component. That is, the pulse laser beam B7, by being transmitted twice through the quarter wave plate 341, the phase of the second polarization component may be shifted by ½ wavelengths in total with respect to the phase of the first polarization component. As a result, the polarization direction of the pulse laser beam B7, linearly polarized in a direction perpendicular to the paper plane, may be rotated by 90 degrees and may be incident on the Pockels cell 340 as a pulse laser beam B10, linearly polarized in a direction parallel to the paper plane.

As stated above, when the voltage from the high voltage power supply 343 is not applied to the Pockels cell 340, the Pockels cell 340 may transmit the incident pulse laser beam without rotating the polarization direction. Accordingly, a pulse laser beam B11 transmitted through the Pockels cell 340 may be incident on the polarization beam splitter 339 as a linearly polarized pulse laser beam polarized in a direction parallel to the paper plane. The polarization beam splitter 339 may transmit the pulse laser beam B11 linearly polarized in the direction parallel to the paper plane with high transmittance.

The flat mirror 338 may reflect with high reflectance a pulse laser beam B12 which was transmitted through the polarization beam splitter 339. The concave mirror 337 may reflect a pulse laser beam B13 from the flat mirror 338 with high reflectance. The laser crystal 336 may amplify and transmit a pulse laser beam B14 as a seed beam from the concave mirror 337.

The flat mirror 334 may reflect a pulse laser beam B15 from the laser crystal 336 with high reflectance back to the laser crystal 336 as a pulse laser beam B16. A pulse laser beam B17 amplified by the laser crystal 336 may be incident on the concave mirror 337. The pulse laser beam may then be incident on the flat mirror 338, then be incident on the polarization beam splitter 339, then be incident on the Pockels cell 340, and then be incident on the quarter wave plate 341 as a pulse laser beam B21. The pulse laser beam B21 may be transmitted through the quarter wave plate 341, then be reflected by the concave mirror 335, and then be transmitted again through the quarter wave plate 341, to thereby be converted into a linearly polarized pulse laser beam B24 polarized in a direction perpendicular to the paper plane. The pulse laser beam B24 may be transmitted through the Pockels cell 340, then be reflected by the polarization beam splitter 339, and outputted as a pulse laser beam B26 to the outside of the optical resonator.

The pulse laser beam B26 may be reflected by the high reflection mirror 333, then be reflected by the high reflection mirror 332, and then be incident on the Faraday optical isolator 331 as a pulse laser beam B28 from the upper side in FIG. 5. The Faraday optical isolator 331 may transmit the linearly polarized pulse laser beam B28, without rotating the polarization direction thereof, as a pulse laser beam B29. The polarization beam splitter 330 may reflect the linearly polarized pulse laser beam B29 polarized in a direction perpendicular to the paper plane with high reflectance.

A pulse laser beam B30 reflected by the polarization beam splitter 330 may be guided through the laser beam focusing optics 22a shown in FIG. 2 to the plasma generation region 25. However, the pulse laser beam B30 outputted after traveling only once in the optical resonator in the regenerative amplifier 305 may have low light intensity. Even when a droplet target is irradiated with the pulse laser beam B30, the droplet target may not be diffused or turned into plasma.

5.3.2 when Voltage is Applied to the Pockels Cell

The high voltage power supply 343 may turn ON the voltage to the Pockels cell 340 at given timing after one pulse of the pulse laser beam B11 is once transmitted through the Pockels cell 340 and before the pulse is then incident on the Pockels cell 340 as the pulse laser beam B20. When the voltage is applied to the Pockels cell 340 by the high voltage power supply 343, the Pockels cell 340 may, similarly to the quarter wave plate 341, shift the phase of the second polarization component by ¼ wavelengths with respect to the phase of the first polarization component.

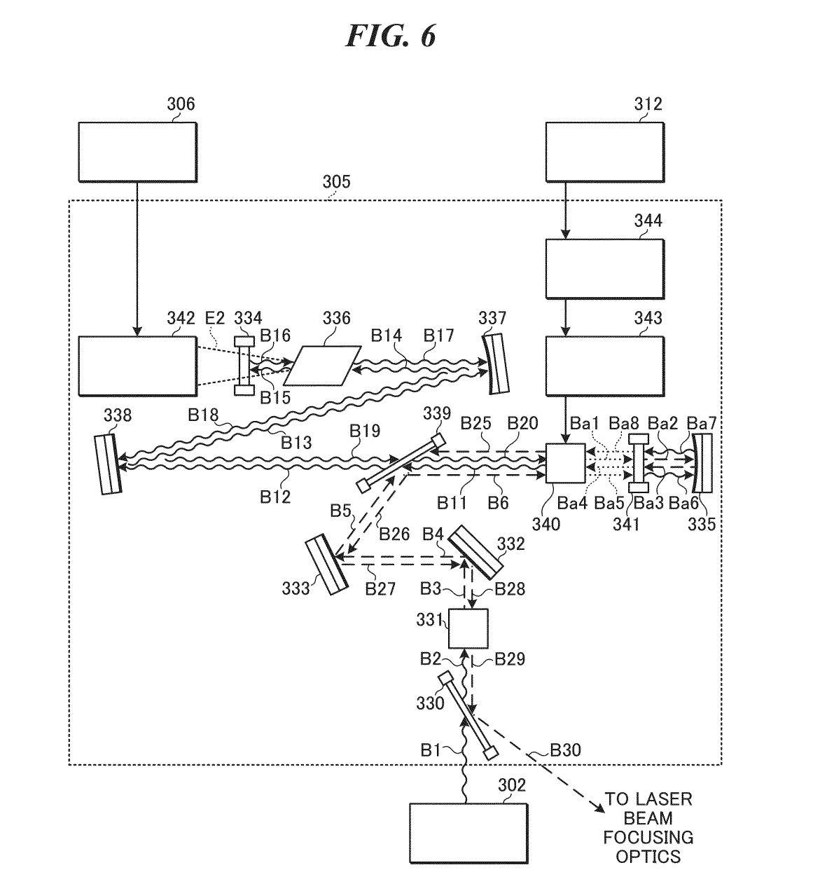

FIG. 6 schematically illustrates a beam path in the regenerative amplifier 305 shown in FIG. 5 when the voltage is applied to the Pockels cell 340. In this situation, the pulse laser beam B20 may be transmitted through the Pockels cell 340 twice and the quarter wave plate 341 twice, as indicated by pulse laser beams Ba1, Ba2, Ba3, and Ba4, and may return as the pulse laser beam B11. The pulse laser beam B11 that has been transmitted through the quarter wave plate 341 twice and transmitted through the Pockels cell 340 twice to which the voltage is applied may have its polarization direction oriented toward the same direction as that of the pulse laser beam B20. Accordingly, the pulse laser beam B11 may be transmitted through the polarization beam splitter 339 and be amplified by the laser crystal 336. While the voltage is applied to the Pockels cell 340 by the high voltage power supply 343, this amplification operation may be repeated.

After the amplification operation is repeated, the high voltage power supply 343 may set the voltage applied to the Pockels cell 340 to OFF at given timing after one pulse of the pulse laser beam B11 is transmitted through the Pockels cell 340 and before the pulse is incident on the Pockels cell 340 as the pulse laser beam B20. As stated above, when the voltage is not applied to the Pockels cell 340 from the high voltage power supply 343, the Pockels cell 340 may not rotate polarization direction of the incident pulse laser beam. Accordingly, the pulse laser beam B20 incident on the left side surface of the Pockels cell 340 when the voltage is not applied thereto may have its polarization direction rotated only by 90 degrees as it is transmitted through the quarter wave plate 341 twice as the pulse laser beams B21, B22, B23, and B24 shown in FIG. 5. Thus, the pulse laser beam after the amplification operation is repeated may be incident on the right side receiving surface of the polarization beam splitter 339 as the linearly polarized pulse laser beam B25 polarized in a direction perpendicular to the paper plane and be outputted to the outside of the optical resonator.

While the voltage is applied to the Pockels cell 340 and the amplification operation is repeated as shown in FIG. 6, a pulse laser beam B1 newly outputted from the mode-locked laser device 302 may be incident on the Pockels cell 340 as the linearly polarized pulse laser beam B6 polarized in a direction perpendicular to the paper plane. While the voltage is applied to the Pockels cell 340, the pulse laser beam B6 may be transmitted through the quarter wave plate 341 twice and the Pockels cell 340 twice as the pulse laser beams Ba5, Ba6, Ba7, and Ba8 and return as the pulse laser beam B25. In this situation, the pulse laser beam B25 may have the same polarization direction as that of the pulse laser beam B6. Accordingly, the pulse laser beam B25 may be reflected by the right side receiving surface of the polarization beam splitter 339, and outputted as a pulse laser beam B26 to the outside of the optical resonator without being amplified even once.

Timing at which the high voltage power supply 343 sets the voltage applied to the Pockels cell 340 to ON/OFF may be determined by the AND signal of the clock signal and the timing signal described above. The AND signal may be supplied from the AND circuit 312 to the voltage waveform generation circuit 344 in the regenerative amplifier 305. The voltage waveform generation circuit 344 may generate voltage waveform using the AND signal as a trigger, and supply this voltage waveform to the high voltage power supply 343. The high voltage power supply 343 may generate the pulse voltage in accordance with the voltage waveform and apply this pulse voltage to the Pockels cell 340. The timing signal, the AND signal, and the voltage waveform by the voltage waveform generation circuit 344 will be described later with reference to FIGS. 7C through 7E.

5.4 Timing Control

FIGS. 7A through 7E are timing charts of various signals in the pre-pulse laser apparatus 300 shown in FIG. 3. FIG. 7A is a timing chart of the clock signal outputted from the clock generator 301. The clock generator 301 may be configured to output the clock signal, for example, at a repetition rate of 100 MHz. In this case, the interval of the pulses may be 10 ns.

FIG. 7B is a timing chart of the detection signal outputted from the pulse laser beam detector 304. The repetition rate of the detection signal from the pulse laser beam detector 304 may depend on the repetition rate of the pulse laser beam outputted from the mode-locked laser device 302. The repetition rate of the pulse laser beam from the mode-locked laser device 302 may be adjusted by controlling the resonator length of the mode-locked laser device 302. In this example, the repetition rate of the pulse laser beam may be approximately 100 MHz. By fine-tuning the repetition rate of the pulse laser beam, the phase difference from the clock signals shown in FIG. 7A may be adjusted. Thus, a feedback-control may be carried out on the mode-locked laser device 302 so that the detection signal of the pulse laser beam is in synchronization with the clock signal shown in FIG. 7A at a delay time of, for example, 5 ns.

FIG. 7C is a timing chart of a timing signal outputted from the delay circuit 53. As stated above, the timing signal from the delay circuit 53 may be a signal which represents the timing at which a predetermined delay time has passed from the timing of the target detection signal by the target sensor 4. The repetition rate of the timing signal may depend on the repetition rate of the droplet targets outputted from the target supply device 26. The droplet targets may be outputted from the target supply device 26, for example, at a repetition rate of approximately 100 kHz. The pulse duration of the timing signal may be substantially equal to an interval between pulses of the clock signal shown in FIG. 7A. Therefore, the pulse duration of the timing signal may be, for example, 10 ns.

FIG. 7D is a timing chart of the AND signal outputted from the AND circuit 312. The AND signal from the AND circuit 312 may be a signal of a logical product of the clock signal and the timing signal. When the pulse duration of the timing signal is substantially the same as the interval of the clock signal, a single pulse of the AND signal may be generated for a single pulse of the timing signal. The AND signal may be generated to be substantially in synchronization with some of multiple pulses of the clock signal.

FIG. 7E is a timing chart of the voltage waveform outputted from the voltage waveform generation circuit 344. The voltage waveform from the voltage waveform generation circuit 344 may be substantially in synchronization with the AND signal from the AND circuit 312. The voltage waveform may, for example, have a pulse duration of 300 ns. For example, if the resonator length of the regenerative amplifier 305 is 1 m, it may take 300 ns for the pulse laser beam at the speed of light of 3×10⁸ m/s to travel 50 times back and forth in the optical resonator. By setting pulse duration of the voltage waveform, the number of times of traveling of the pulse laser beam in the optical resonator of the regenerative amplifier 305 may be set.

With the above timing control, the pulse laser beam from the mode-locked laser device 302 may be in synchronization with the clock signal at a constant delay time, and the AND signal may be in synchronization with some of the pulses of the clock signal. Thus, while the pulse laser beam travels in a specific section of the optical resonator in the regenerative amplifier 305, the voltage applied to the Pockels cell 340 from the high voltage power supply 343 may be set to ON or OFF. Accordingly, only desired pulses in the pulse laser beam from the mode-locked laser device 302 may be amplified to desired light intensity, and outputted to strike a droplet target.

Further, with the above-described timing control, timing of pulses from the regenerative amplifier 305 may be controlled with resolving power in accordance with the interval of the pulses from the mode-locked laser device 302. For example, a droplet target which is outputted from the target supply device 26 and is traveling inside the chamber 2 at a speed of 30 m/s to 60 m/s may move 0.3 μm to 0.6 μm in 10 ns, which is the interval of the pulses from the mode-locked laser device 302. When the diameter of the droplet target is 20 μm, the resolving power of 10 ns may be sufficient to irradiate the droplet target with the pulse laser beam.

### 6. Main Pulse Laser Apparatus

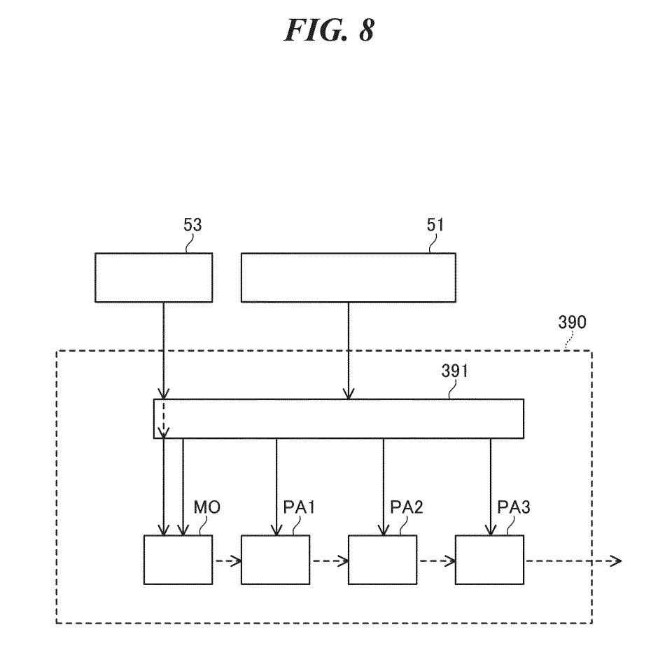

FIG. 8 schematically illustrates a configuration example of the main pulse laser apparatus 390 in the first embodiment. The main pulse laser apparatus 390 may include a master oscillator MO, amplifiers PA1, PA2, and PA3, and a controller 391.

The master oscillator MO may be a CO₂ laser apparatus in which a CO₂ gas is used as a laser medium, or may be a quantum cascade laser apparatus configured to oscillate in a wavelength region corresponding to that of the CO₂ laser apparatus. The amplifiers PA1, PA2, and PA3 may be provided in series in a beam path of a pulse laser beam outputted from the master oscillator MO. Each of the amplifiers PA1, PA2, and PA3 may include a laser chamber (not shown) in which a CO₂ gas is contained as a laser medium, a pair of electrodes (not shown) provided inside the laser chamber, and a power supply (not shown) configured to apply voltage between the pair of electrodes. In the following description, the CO₂ gas may be used as a laser medium gas after being diluted with other gases such as nitrogen, helium, neon, or xenon gas.

The controller 391 may control the master oscillator MO and the amplifiers PA1, PA2, and PA3 based on a control signal from the EUV controller 51. The controller 391 may output the timing signal from the delay circuit 53 to the master oscillator MO. The timing signal from the delay circuit 53 may be the second timing signal mentioned above. The master oscillator MO may output each pulse of the pulse laser beam in accordance with each pulse of the timing signal serving as a trigger. The pulse laser beam may be amplified in the amplifiers PA1, PA2, and PA3. Thus, the main pulse laser apparatus 390 may output the main pulse laser beam in synchronization with the timing signal from the delay circuit 53.

### 7. Others

7.1 Variation of the Timing Signal

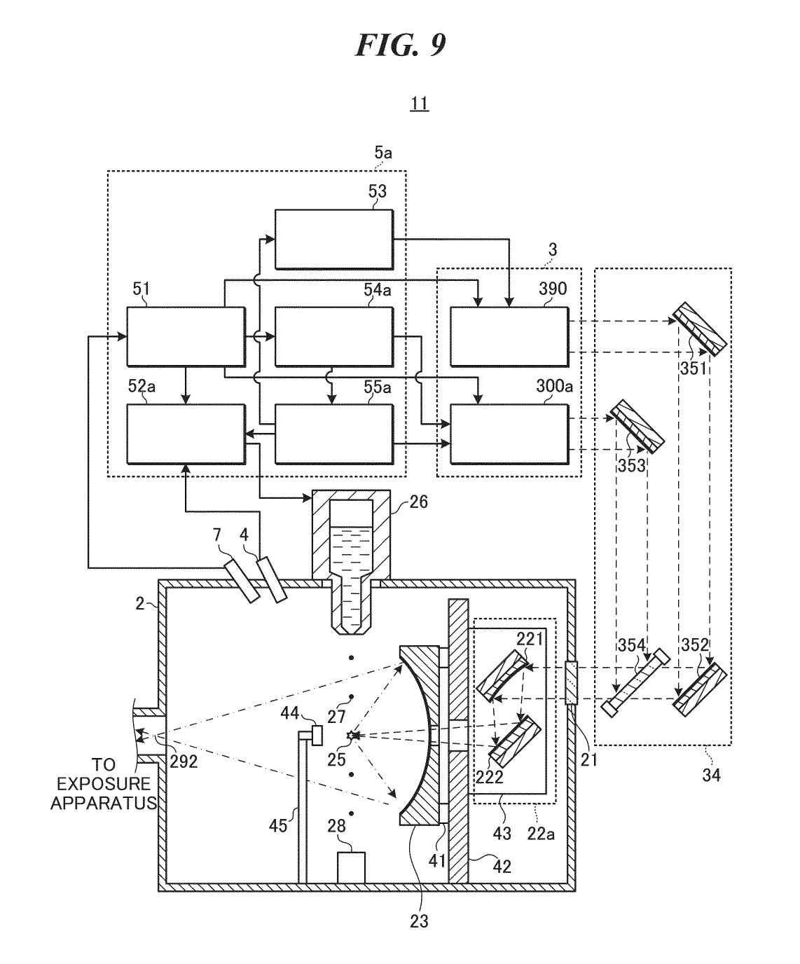

FIG. 9 is a partial cross-sectional view schematically showing a configuration example of the EUV light generation system 11 according to a second embodiment. In the second embodiment, an EUV light generation controller 5a may include a clock generator 54a and a frequency divider 55a.

The clock generator 54a can output a clock signal, for example, having a repetition rate of 100 MHz. The frequency divider 55a may output a third timing signal having repetition rate lower than the repetition rate of the clock signal from the clock generator 54a, based on the clock signal. The frequency divider 55a may include a counter circuit (not shown). The frequency divider 55a may output the third timing signal at each time of counting a predetermined number of pulses of the clock signal.

A target controller 52a may include a phase adjusting unit (not shown). The phase adjusting unit may detect a phase difference between the target detection signal detected by the target sensor 4 and the third timing signal from the frequency divider 55a. The phase adjusting unit may carry out a feedback control on the target supply device 26 so that the target detection signal and the third timing signal are synchronized at a predetermined phase difference.

The pre-pulse laser apparatus 300a may be provided with the third timing signal from the frequency divider 55a, not from the delay circuit 53. The main pulse laser apparatus 390 may be provided by the delay circuit 53 with a fourth timing signal which represents timing at which a predetermined delay time has passed from the timing of the third timing signal.

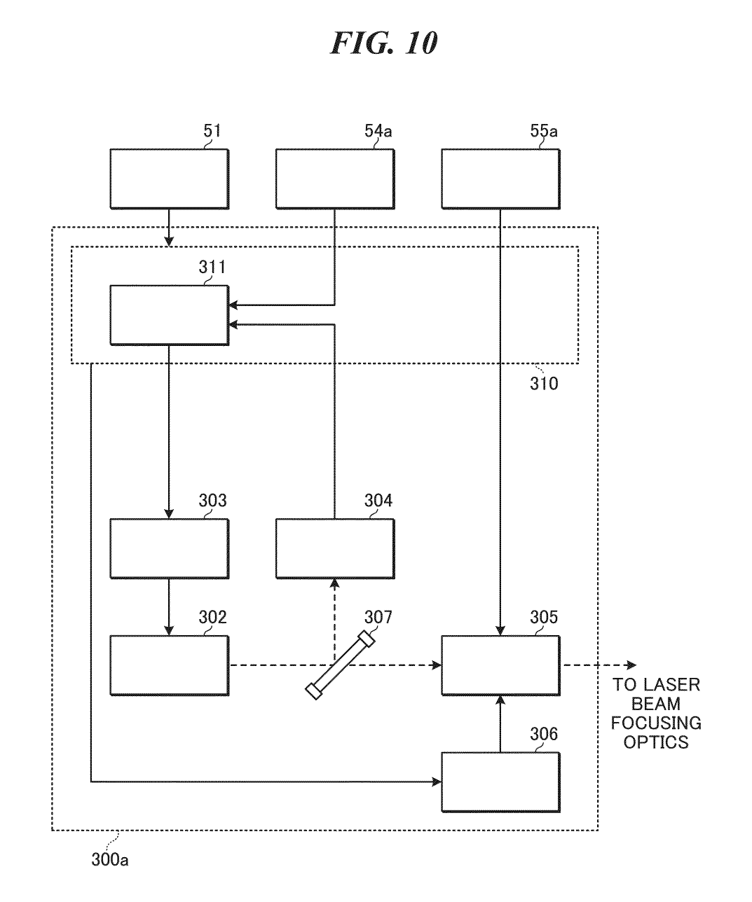

FIG. 10 schematically illustrates a configuration example of the pre-pulse laser apparatus 300a in the second embodiment. In the second embodiment, the clock signal may be supplied from the clock generator 54a of the EUV light generation controller 5a in FIG. 9. Therefore, the clock generator does not have to be included in the pre-pulse laser apparatus 300a. Further, the AND circuit 312 in FIG. 3 does not have to be included. The Pockels cell in the regenerative amplifier 305 may be controlled based on the third timing signal from the frequency divider 55a, instead of the AND signal from the AND circuit 312. The Pockels cell in the regenerative amplifier 305 may be controlled with a predetermined delay time from the third timing signal. The other points may be substantially the same as the first embodiment.

According to the second embodiment, the pulse laser beam from the mode-locked laser device 302 can be synchronized with the clock signal at a predetermined delay time. Further, the target supply device 26 may be controlled to be in synchronization with the third timing signal. In addition, the Pockels cell in the regenerative amplifier 305 can be controlled at a predetermined delay time from the third timing signal. Since the third timing signal is outputted from the frequency divider 55a based on the clock signal, the third timing signal can be synchronized with some pulses of multiple pulses of the clock signal. Therefore, as in the first embodiment, only desired pulses in the pulse laser beam from the mode-locked laser device 302 may be amplified to desired light intensity, and outputted to strike a droplet target.

7.2 Variation of the Pre-Pulse Laser Apparatus (1)

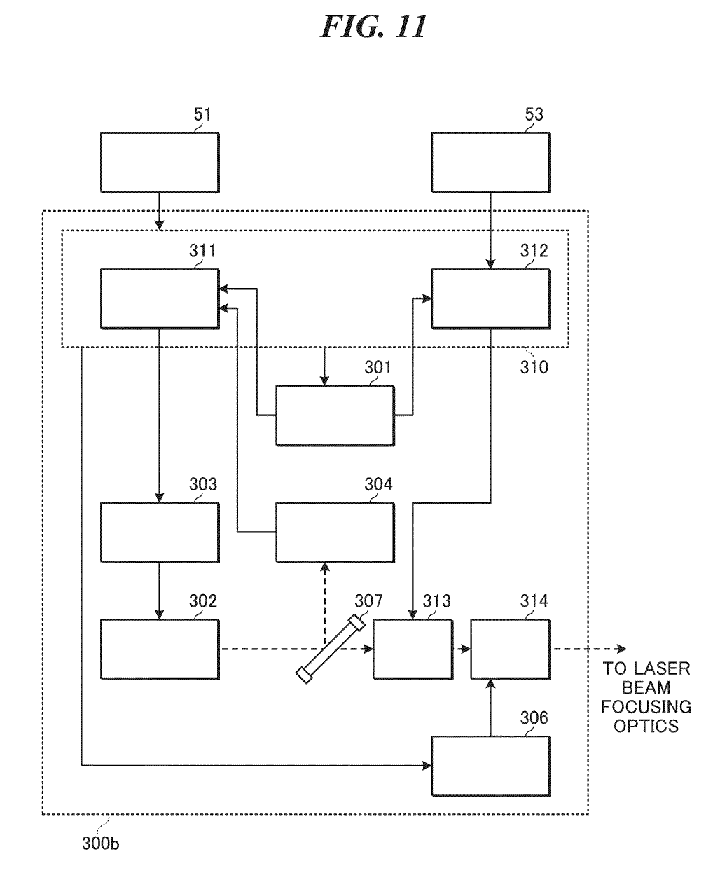

FIG. 11 schematically illustrates a configuration example of a pre-pulse laser apparatus 300b according to a third embodiment. Instead of the regenerative amplifier 305 of FIG. 3 including the Pockels cell 340 in FIG. 5 of the first embodiment, the pre-pulse laser apparatus 300b in the third embodiment includes an optical shutter 313 and an amplifier 314. The other points may be substantially the same as in the first embodiment.

The optical shutter 313 may include a voltage waveform generation circuit (not shown), a high voltage power supply (not shown), a Pockels cell (not shown), and a polarizer (not shown). The voltage waveform generation circuit may generate voltage waveform using the AND signal from the AND circuit 312 as a trigger, and supply the voltage waveform to the high voltage power supply. The high voltage power supply may generate pulse voltage according to the voltage waveform, and apply the pulse voltage to the Pockels cell included in the optical shutter 313.

The Pockels cell in the optical shutter 313 may change the polarization direction of the pulse laser beam passing through the Pockels cell depending on applying or non-applying of the voltage by the high voltage power supply. The polarizer may, depending on the polarization direction of the pulse laser beam, transmit the pulse laser beam if the polarization direction is a first direction, and reflect or absorb the pulse laser beam if the polarization direction is a second direction.

The amplifier 314 may be an optical fiber amplifier including an optical fiber. The amplifier 314 may include an ytterbium (Yb)-doped optical fiber (not shown), and an excitation light source (not shown) such as a laser diode. The amplifier 314 may be disposed in an optical path of the pulse laser beam transmitted through the optical shutter 313, and may amplify the pulse laser beam transmitted through the optical shutter 313.

According to the third embodiment, desired pulses in the pulse laser beam from the mode-locked laser device may be amplified, and outputted to strike a droplet target.

7.3 Variation of the Pre-Pulse Laser Apparatus (2)

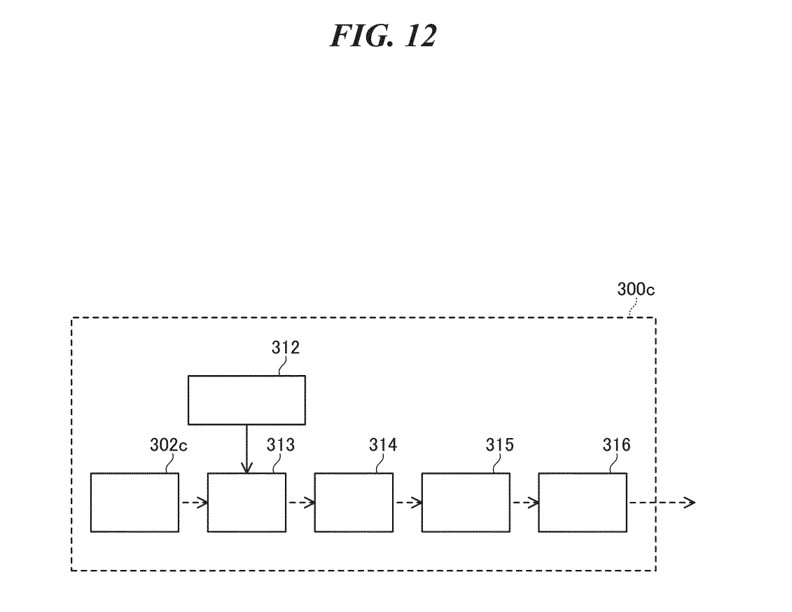

FIG. 12 schematically illustrates a configuration example of a pre-pulse laser apparatus 300c according to a fourth embodiment. The pre-pulse laser apparatus 300c in the fourth embodiment may include a mode-locked laser device 302c, the optical shutter 313, the amplifier 314, a first nonlinear crystal 315, and a second nonlinear crystal 316. The other points may be substantially the same as the third embodiment. The pre-pulse laser apparatus 300c may include the clock generator 301, the resonator length controlling driver 303, the pulse laser beam detector 304, the excitation power supply 306, the beam splitter 307, and the controller 310 shown in FIG. 11.

The mode-locked laser device 302c may have ytterbium-doped glass as a laser medium and may output a pulse laser beam, for example, at a repetition rate of approximately 100 MHz. The mode-locked laser device 302c may output the pulse laser beam at a wavelength λ1 of 1040 nm and a pulse duration of 100 ps.

The optical shutter 313 and the amplifier 314 may be substantially the same as those described in the third embodiment. The optical shutter 313 may control the transmission or interruption of the pulse laser beam outputted from the mode-locked laser device 302c. The amplifier 314 may amplify the pulse laser beam transmitted through the optical shutter 313.

The first nonlinear crystal 315 may be a lithium niobate (LiNbO₃) crystal. The first nonlinear crystal 315 may be disposed in an optical path of the pulse laser beam amplified by the amplifier 314. The first nonlinear crystal 315 may convert the pulse laser beam having the wavelength λ1, by optical parametric oscillation, to a pulse laser beam having a wavelength λ2 of 1680 nm and a pulse laser beam having a wavelength λ3 of 2730 nm. Here, relationship between the wavelengths may be as follows:

1/λ1=1/λ2+1/λ3

The second nonlinear crystal 316 may be a cadmium selenide (CdSe) crystal. The second nonlinear crystal 316 may be disposed in an optical path of the pulse laser beam having the wavelength λ2 outputted from the first nonlinear crystal 315. The second nonlinear crystal 316 may convert the pulse laser beam having the wavelength λ2, by optical parametric oscillation, to a pulse laser beam having a wavelength λ4 of 10600 nm and a pulse laser beam having a wavelength λ5 of 1996.4 nm. Here, relationship between the wavelengths may be as follows:

1/λ2=1/λ4+1/λ5

Accordingly, the pulse laser beam having a wavelength λ4 of 10600 nm may be obtained as an output beam. The wavelength λ4 may be substantially equal to the wavelength of the pulse laser beam by the CO₂ laser apparatus. Thus, if a CO₂ laser apparatus is used as the main pulse laser apparatus 390 of FIG. 8, even when the pre-pulse laser beam and the main pulse laser beam are focused by a common lens, the focal points may be substantially the same by suppressing chromatic aberration.

7.4 Variation of the Pre-Pulse Laser Apparatus (3)

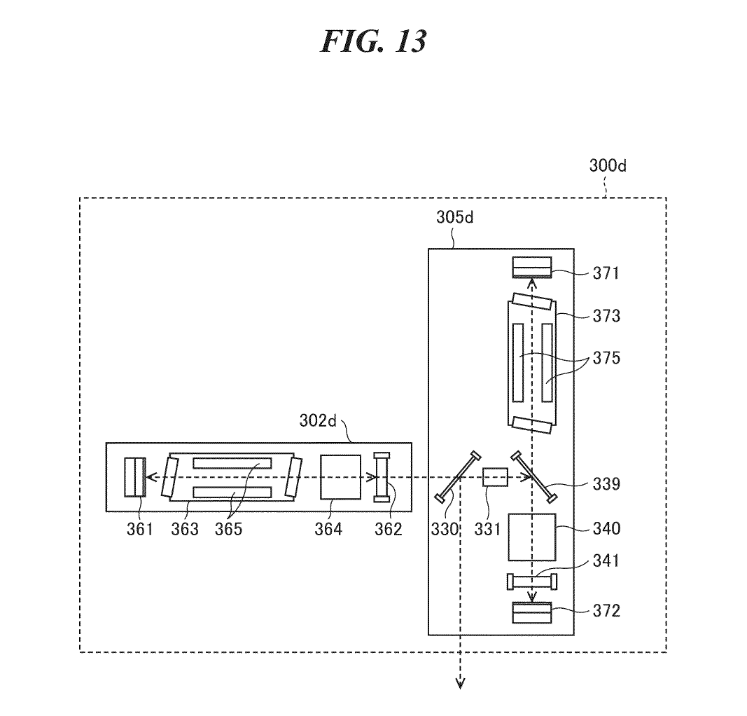

FIG. 13 schematically illustrates a configuration example of a pre-pulse laser apparatus 300d according to a fifth embodiment. The pre-pulse laser apparatus 300d according to the fifth embodiment may include a mode-locked laser device 302d and a regenerative amplifier 305d. The other points may be substantially the same as the first embodiment shown in FIG. 3. The pre-pulse laser apparatus 300d may include the clock generator 301, the resonator length controlling driver 303, the pulse laser beam detector 304, the excitation power supply 306, the beam splitter 307, and the controller 310.

The mode-locked laser device 302d may be a CO₂ laser oscillator. The mode-locked laser device 302d may include an optical resonator formed by a high reflection mirror 361 and an output coupler mirror 362. In the optical resonator, a laser chamber 363 and a saturable absorption cell 364 may be provided in this order from the side of the high reflection mirror 361. In the laser chamber 363, a pair of electrodes 365 may be disposed and a CO₂ gas may be contained as a laser medium. Voltage can be applied to the pair of electrodes 365 by a power source (not shown).

The regenerative amplifier 305d may include an optical resonator including a pair of high reflection mirrors 371 and 372. In the optical resonator, a laser chamber 373, a polarization beam splitter 339, a Pockels cell 340, and a quarter wave plate 341 may be provided in this order from the side of the high reflection mirror 371. In the laser chamber 373, a pair of electrodes 375 may be disposed, and a CO₂ gas may be contained as a laser medium. Voltage can be applied to the pair of electrodes 375 by a power source (not shown). Further, the regenerative amplifier 305d may include a polarization beam splitter 330 and a Faraday optical isolator 331.

The total gas pressure in the laser chamber 363 and the total gas pressure in the laser chamber 373 may be controlled in a range between 3 atm and 10 atm. With the gas pressure noted above, an amplifiable wavelength region by the CO₂ gas may widen, and thus oscillation in multiple longitudinal modes may be achieved and generation of a pulse laser beam having a pulse duration of 1 ps to 200 ps may be achieved.

7.5 Pulse Duration of the Pre-Pulse Laser Beam

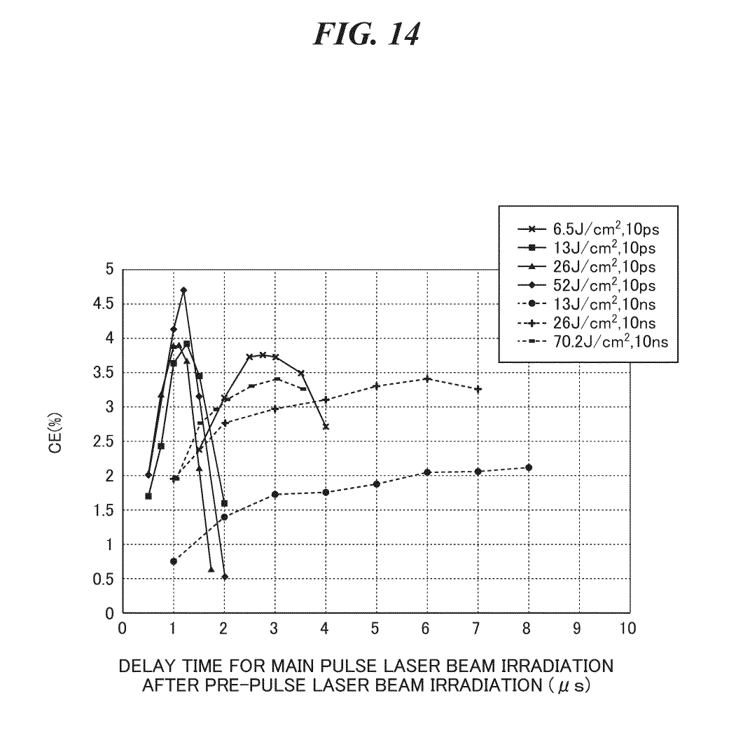

FIG. 14 is a graph showing a relationship between an irradiation condition of the pre-pulse laser beam and CE in the EUV light generation system 11. In FIG. 14, a delay time (μs) for the main pulse laser beam from the pre-pulse laser beam is plotted along the horizontal axis, and the CE (%) from energy of the main pulse laser beam into energy of the EUV light is plotted along the vertical axis. Seven combination patterns of pulse duration defined by full width at half maximum and fluence as a measure of energy density of the pre-pulse laser beam were set, and a measurement was carried out on each combination pattern. Obtained results are shown in a line graph. Here, the fluence may be a value in which energy of the pulse laser beam is divided by area of the focusing spot. The area of the focusing spot may be area of a portion having light intensity equal to or higher than 1/e² of the peak intensity at the focusing spot.

Details of the measurement conditions are as follows. Tin (Sn) was used as the target material, and tin was molten to generate a droplet target having a diameter of 21 μm. As the pre-pulse laser apparatus, an Nd:YAG laser apparatus was used to generate a pre-pulse laser beam having a pulse duration of 10 ns. The wavelength of this pre-pulse laser beam was 1.06 μm and the pulse energy was 0.5 mJ to 2.7 mJ. To generate a pre-pulse laser beam having a pulse duration of 10 ps, a mode-locked laser device including an Nd:YVO₄ crystal was used as the master oscillator, and another laser device including an Nd:YAG crystal was used as the regenerative amplifier. The wavelength of this pre-pulse laser beam was 1.06 μm and the pulse energy thereof was 0.25 mJ to 2 mJ. The focusing spot diameter of each of the pre-pulse laser beams was 70 μm. As the main pulse laser apparatus, a CO₂ laser apparatus was used to generate a main pulse laser beam. The wavelength of the main pulse laser beam was 10.6 μm and the pulse energy thereof was 135 mJ to 170 mJ. The pulse duration of the main pulse laser beam was 15 ns, and the focusing spot diameter thereof was 300 μm.

The measurement results were as follows. As shown in FIG. 14, in the cases where the pulse duration of the pre-pulse laser beam was 10 ns, the CE did not reach 3.5% at the maximum. Further, in the cases where the pulse duration of the pre-pulse laser beam was 10 ns, the CE reached the maximum in each combination pattern when a delay time for the main pulse laser beam from the pre-pulse laser beam was equal to or greater than 3 μs.

In other cases where the pulse duration of the pre-pulse laser beam was 10 ps, the maximum value of the CE in each combination pattern exceeded 3.5%. These maximum values were obtained when the delay time for the main pulse laser beam from the pre-pulse laser beam was smaller than 3 μs. In particular, a CE of 4.7% was achieved in a situation where: the pulse duration of the pre-pulse laser beam was 10 ps; the fluence was 52 J/cm²; and the delay time for the main pulse laser beam from the pre-pulse laser beam was 1.2 μs.

The above-described results reveal that higher CE may be achieved in the cases where the pulse duration of the pre-pulse laser beam is in a picosecond range (e.g., 10 ps) rather than in the cases where the pulse duration thereof is in a nanosecond range (e.g., 10 ns). Further, an optimal delay time for the main pulse laser beam from the pre-pulse laser beam to obtain the highest CE was smaller in the cases where the pulse duration of the pre-pulse laser beam was in the picosecond range compared to the cases where the pulse duration thereof was in the nanosecond range. Accordingly, to generate EUV light at higher repetition rate, it is preferable that the pulse duration of the pre-pulse laser beam is in the picosecond range rather than in the nanosecond range.

Further, based on the results shown in FIG. 14, when the pulse duration of the pre-pulse laser beam is in the picosecond range and the fluence is 13 J/cm² to 52 J/cm², the delay time for the main pulse laser beam from the pre-pulse laser beam may preferably be set as follows:

0.5 μs or more, and 1.8 μs or less;

more preferably, 0.7 μs or more, and 1.6 μs or less;

still more preferably, 1.0 μs or more, and 1.4 μs or less.

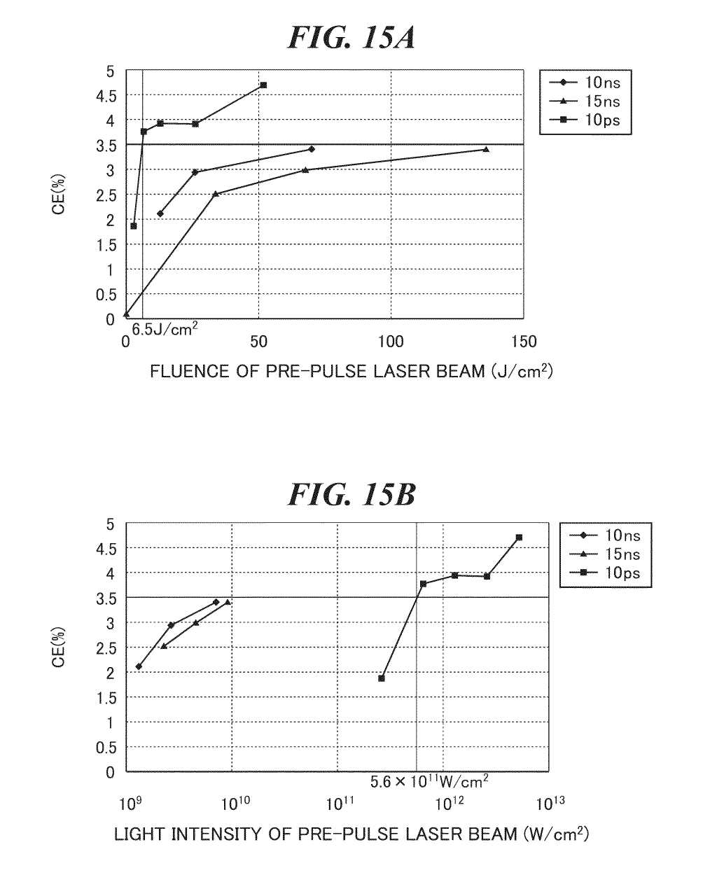

FIG. 15A is a graph showing a relationship between fluence of the pre-pulse laser beam and CE in the EUV light generation system 11. In FIG. 15A, the fluence (J/cm²) of a pre-pulse laser beam is plotted along the horizontal axis, and the CE (%) is plotted along the vertical axis. In each of the cases where the pulse duration of the pre-pulse laser beam was set to 10 ps, 10 ns, and 15 ns, the CE was measured for various delay times for the main pulse laser beam from the pre-pulse laser beam, and the CE at the optimal delay time was plotted. Here, the results shown in FIG. 14 were used to fill a part of the data where the pulse duration was 10 ps or 10 ns. Further, in order to generate a pre-pulse laser beam having a pulse duration of 15 ns, a pre-pulse laser apparatus configured similarly to the one used to generate the pre-pulse laser beam having a pulse duration of 10 ns was used.

In all of the cases where the pulse duration of the pre-pulse laser beam was 10 ps, 10 ns, and 15 ns, the CE increased with the increase in the fluence of the pre-pulse laser beam, and the CE saturated when the fluence exceeded respective predetermined values. Further, when the pulse duration was 10 ps, compared to the case where the pulse duration was 10 ns or 15 ns, higher CE was obtained and lower fluence was required to obtain that CE. When the pulse duration was 10 ps, if the fluence was increased from 2.6 J/cm² to 6.5 J/cm², the CE improved greatly, and if the fluence exceeded 6.5 J/cm², the rate of improving in the CE with respect to the increase in the fluence was reduced.

FIG. 15B is a graph showing a relationship between light intensity of the pre-pulse laser beam and the CE in the EUV light generation system 11. In FIG. 15R, the light intensity (W/cm²) of the pre-pulse laser beam is plotted along the horizontal axis, and the CE (%) is plotted along the vertical axis. The light intensity was calculated from the results shown in FIG. 15A. Here, the light intensity may be a value obtained by dividing the fluence of the pre-pulse laser beam by the pulse duration defined by the full width at half maximum.

In all of the cases where the pulse duration of the pre-pulse laser beam was 10 ps, 10 ns, and 15 ns, the CE increased with the increase in the light intensity of the pre-pulse laser beam. Further, higher CE was obtained when the pulse duration was 10 ps, compared to the case where the pulse duration was 10 ns or 15 ns. When the pulse duration was 10 ps, the CE greatly improved if the light intensity was in a range from 2.6×10¹¹ W/cm² to 5.6×10¹¹ W/cm², and an even higher CE was obtained when the light intensity exceeded 5.6×10¹¹ w/cm².

As described above, by using the pre-pulse laser apparatuses according to the first through fifth Embodiments, it may be possible to irradiate the target with the pre-pulse laser beam having short pulse duration, and to improve the CE.

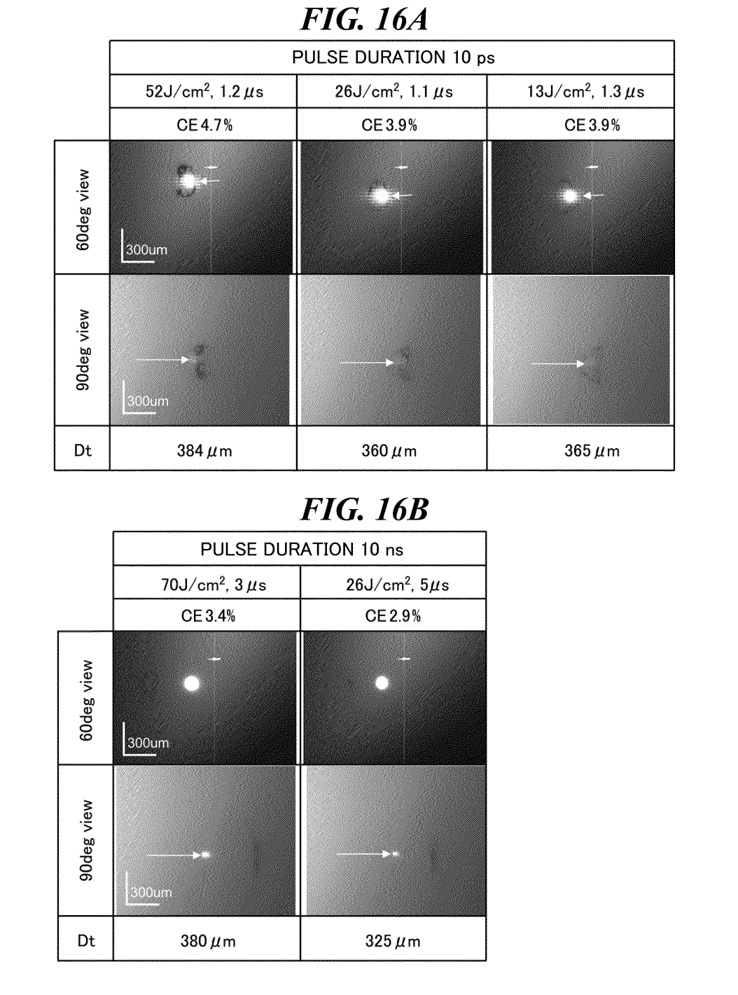

FIGS. 16A and 16B show photographs of a diffused target after the droplet target is irradiated with the pre-pulse laser beam in the EUV light generation system 11. Each of the photographs shown in FIGS. 16A and 16B was captured at the respective optimal delay time for the main pulse laser beam from the pre-pulse laser beam to obtain the highest CE. That is, FIG. 16A is obtained by capturing the diffused target at the timing of less than 3 is after irradiation of the pre-pulse laser beam. FIG. 16B is obtained by capturing the diffused target at the timing of 3 μs or more after irradiation of the pre-pulse laser beam. In order to observe the diffusion state of the target, the target was not irradiated with the main pulse laser beam. FIG. 16A shows photographs in the cases where the pulse duration of the pre-pulse laser beam was set to 10 ps and the fluence thereof was set to three different values. FIG. 16B shows photographs in the cases where the pulse duration of the pre-pulse laser beam was set to 10 ns and the fluence thereof was set to two different values. In both of FIGS. 16A and 16B, the diffused target was captured at an angle of 60 degrees and 90 degrees with respect to the traveling direction of the pre-pulse laser beam.

The diameter Dt of the diffused target was 360 μm to 384 μm when the pulse duration of the pre-pulse laser beam was 10 ps, and the diameter Dt was 325 μm to 380 μm when the pulse duration of the pre-pulse laser beam was 10 ns. In other words, the diameter Dt of the diffused target was somewhat larger than 300 μm, which was the focusing spot diameter of the main pulse laser beam. However, the focusing spot diameter of the main pulse laser beam here may be the diameter of a portion having light intensity equal to or higher than 1/e² of the peak intensity at the focusing spot. Thus, even when the diameter Dt of the diffused target is 400 μm, the diffused target may be irradiated with most of the main pulse laser beam.

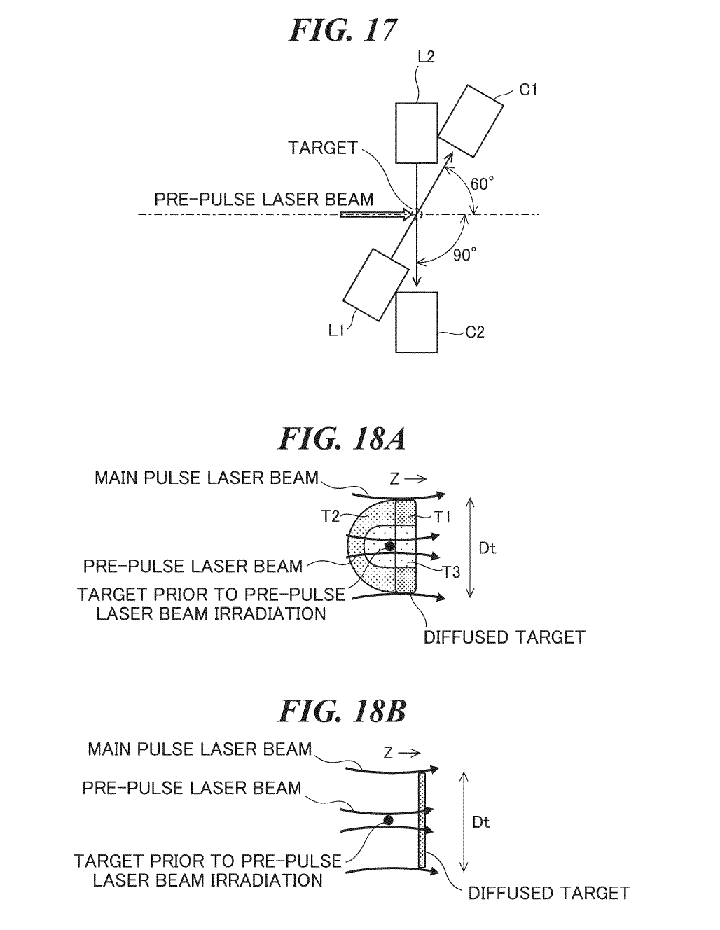

FIG. 17 schematically illustrates an arrangement of equipment used to capture the photographs shown in FIGS. 16A and 16B. As shown in FIG. 17, cameras C1 and C2 are respectively arranged at 60 degrees and 90 degrees to the traveling direction of the pre-pulse laser beam, and flash lamps L1 and L2 are respectively arranged to oppose the cameras C1 and C2 with reference to a point where a droplet target located therebetween is irradiated.

FIGS. 18A and 18B are sectional views schematically illustrating the diffused targets respectively shown in FIGS. 16A and 16B. As shown in FIGS. 16A and 18A, when the pulse duration of the pre-pulse laser beam was 10 ps, the droplet target diffused annularly in the direction in which the pre-pulse laser beam travels, and diffused in a dome shape in the opposite direction. More specifically, the diffused target included a first portion T1 where the target material diffused in an annular shape, a second portion T2 which is adjacent to the first portion T1 and in which the target material diffused in a dome shape, and a third portion T3 surrounded by the first portion T1 and the second portion T2. The density of the target material was higher in the first portion T1 than in the second portion T2, and the density of the target material was higher in the second portion T2 than in the third portion T3.

As shown in FIGS. 16B and 18B, when the pulse duration of the pre-pulse laser beam was 10 ns, the droplet target diffused in a disc shape or in an annular shape. Further, the droplet target diffused toward the Z direction in which the pre-pulse laser beam traveled.

When the pulse duration of the pre-pulse laser beam is in the nanosecond range, laser ablation from the droplet target may occur over a time period in the nanosecond range. During that time period, heat may be conducted to the inside of the droplet target, then a part of the droplet target may be vaporized, or the droplet target may move due to reaction force of the laser ablation. Meanwhile, when the pulse duration of the pre-pulse laser beam is in the picosecond range, the droplet target may be broken up instantaneously before the heat is conducted to the inside of the droplet target. Such a difference in the diffusion process of the droplet target may be a cause for the higher CE with a pre-pulse laser beam having the pulse duration of the picosecond range, rather than having the pulse duration of the nanosecond range.

7.6 Variation of the Main Pulse Laser Apparatus (1)

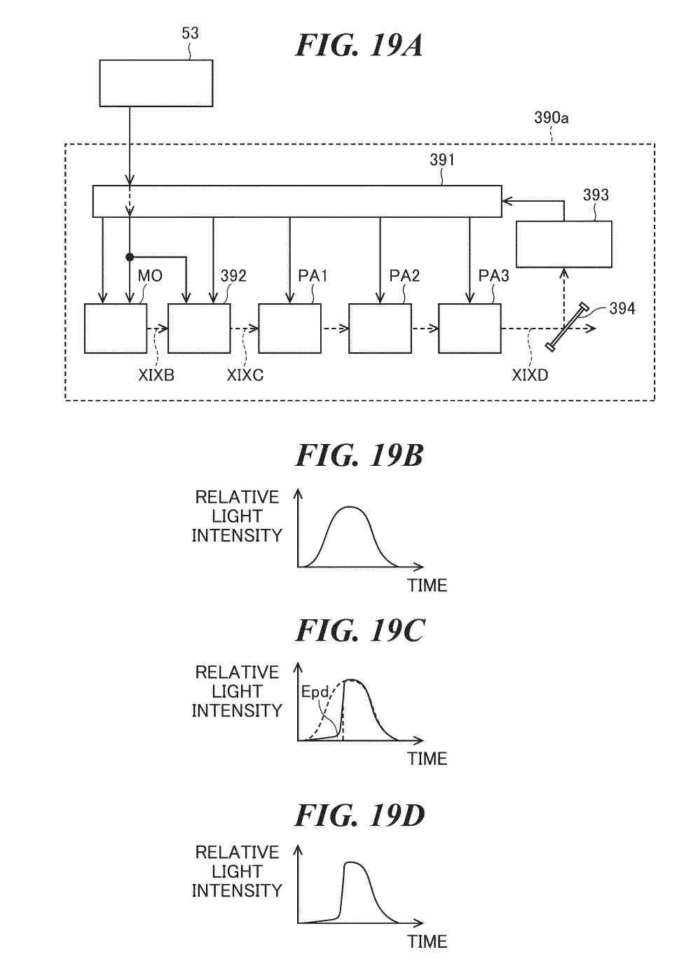

FIG. 19A schematically illustrates a configuration example of a main pulse laser apparatus 390a according to a sixth embodiment. The main pulse laser apparatus 390a in the sixth embodiment may include a waveform controller 392 between the master oscillator MO and the amplifier PA1. Further, the main pulse laser apparatus 390a may include a beam splitter 394 which is disposed in the optical path of the main pulse laser beam outputted from the amplifier PA3. Further, the main pulse laser apparatus 390a may include a pulse wave detector 393 disposed in one of the two optical paths split by the beam splitter 394.

FIG. 19B is a graph showing a pulse waveform of the pulse laser beam outputted from the master oscillator MO and indicated by a broken line XIXB in FIG. 19A. FIG. 19C is a graph showing a pulse waveform of the pulse laser beam outputted from the waveform controller 392 and indicated by a broken line XIXC in FIG. 19A. FIG. 19D is a graph showing a pulse waveform of the pulse laser beam outputted from the amplifier PA3 and indicated by a broken line XIXD in FIG. 19A. In the description of the following embodiments, the vertical axes in the graphs of the pulse waveforms represent relative light intensities normalized by a representative peak value of the pulse waveforms.

The waveform controller 392 may adjust the pulse waveform of the pulse laser beam outputted from the master oscillator MO. For example, a pulse laser beam having the pulse waveform shown in FIG. 19B may be inputted to the waveform controller 392. The waveform controller 392 may output a pulse laser beam having the pulse waveform shown in FIG. 19C. The pulse laser beam having the pulse waveform shown in FIG. 19C may be amplified by the plurality of amplifiers and outputted from the amplifier PA3 as a pulse laser beam having the pulse waveform shown in FIG. 19D. As shown in FIG. 19C, the pulse waveform of the main pulse laser beam outputted from the waveform controller 392 may include: a first stage having low light intensity; a second stage in which the light intensity increases steeply from the first stage to reach a peak value; and a third stage in which the light intensity decreases from the end of the second stage. By irradiating the target with the pre-pulse laser beam to form the diffused target, and then irradiating the diffused target with the main pulse laser beam having the pulse waveform as described above, the CE can be improved. If an integral value of the light intensity in the first stage described above is represented by Epd and an integral value of the light intensity of the whole pulse waveform including the first to third stages is represented by Eto, energy ratio R may be calculated as follows:

R=Epd/Eto

In order to improve the CE, the ratio R may preferably be in the following range:

1%≦R≦7.5%

More preferably, the ratio R may be in the following range:

2%≦R≦5%

In order to maximize the CE, the ratio R may be 3.5%. The controller 391 may control the waveform controller 392 based on the pulse waveform of the main pulse laser beam detected by the pulse wave detector 393. The other points may be substantially the same as that of the first embodiment described with reference to FIG. 8.

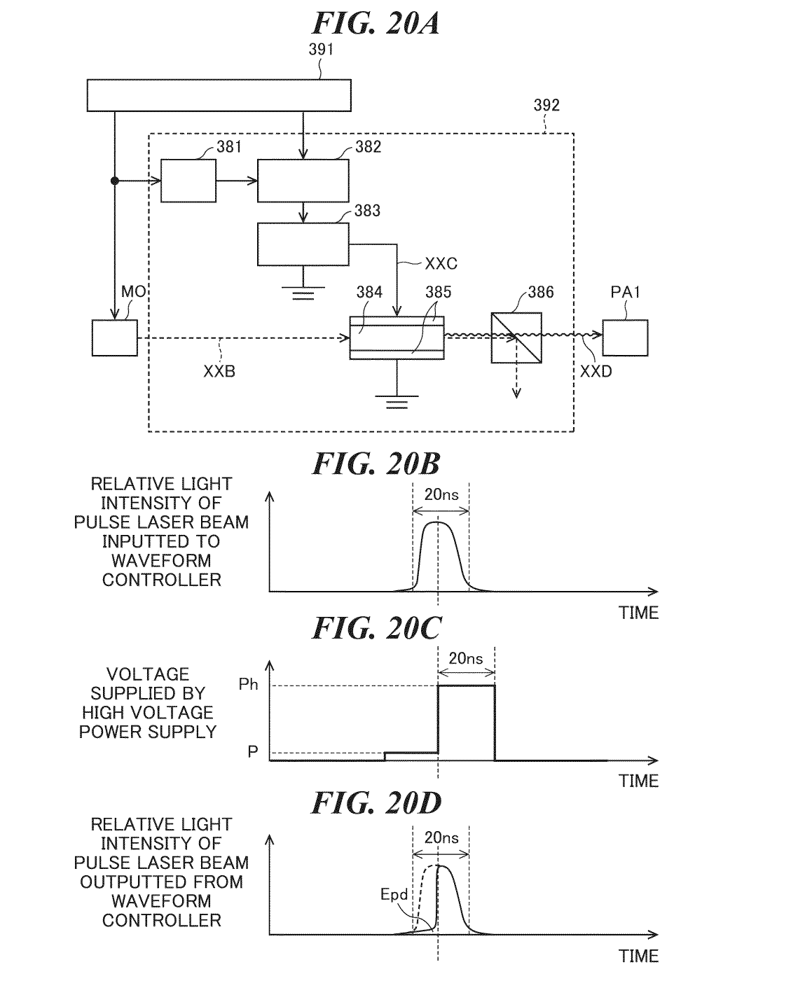

FIG. 20A shows a schematic configuration example of the waveform controller 392 shown in FIG. 19A. The waveform controller 392 may include a delay circuit 381, a voltage waveform generation circuit 382, a high voltage power supply 383, a Pockels cell 384, and a polarizer 386.

The Pockels cell 384 may include a pair of electrodes 385 positioned at both surfaces of the electro-optic crystal. A pulse laser beam outputted from the master oscillator MO may be transmitted between the pair of electrodes 385. The Pockels cell 384, when voltage is applied between the pair of electrodes 385, may transmit the pulse laser beam as rotating the polarization direction by 90 degrees. The Pockels cell 384, when the voltage is not applied between the pair of electrodes 385, may transmit the pulse laser beam without rotating the polarization direction.

The polarizer 386 may transmit a pulse laser beam linearly polarized in the direction parallel to the paper plane at high transmittance toward the amplifier PA1. The polarizer 386 may reflect a pulse laser beam linearly polarized in the direction perpendicular to the paper plane at high reflectance.

The delay circuit 381 may output, to the voltage waveform generation circuit 382, a signal which represents timing at which a predetermined delay time has passed from the timing of the timing signal outputted to the master oscillator MO from the delay circuit 53 in FIG. 19A. The voltage waveform generation circuit 382 may generate voltage waveform using the signal from the delay circuit 381 as a trigger, and supply this voltage waveform to the high voltage power supply 383. The high voltage power supply 383 may generate pulse voltage in accordance with the voltage waveform and apply this pulse voltage to the pair of electrodes 385 of the Pockels cell 384.

FIG. 20B is a graph showing a pulse waveform of the pulse laser beam inputted to the waveform controller 392 as shown in a broken line XXB in FIG. 20A. The pulse laser beam outputted by the master oscillator MO to be inputted to the waveform controller 392 may be linearly polarized in a direction perpendicular to the paper plane and the pulse duration of the pulse laser beam may be 20 ns. The pulse waveform of the pulse laser beam may include: a first stage in which light intensity increases; a second stage in which the light intensity reaches a peak value; and a third stage in which the light intensity decreases from the end of the second stage.

FIG. 20C is a graph showing a waveform of the pulse voltage outputted from the high voltage power supply 383 and transferred through a wire represented by XXC in FIG. 20A. The pulse waveform of the pulse voltage outputted from the high voltage power supply 383 may be a waveform having a relatively low voltage value P at its first half portion, and having a relatively high voltage value Ph at its second half portion. Timing of transition from the first half portion to the second half portion of the pulse waveform of the pulse voltage may be aligned with timing of the peak of the pulse waveform of the pulse laser beam shown in FIG. 20B. The duration of first half portion of the voltage waveform may be approximately 20 ns and the duration of the second half portion may also be approximately 20 ns.

FIG. 20D is a graph showing a pulse waveform of the pulse laser beam outputted from the waveform controller 392 and indicated by a broken line XXD in FIG. 20A. If the pulse voltage shown in FIG. 20C is applied to the Pockels cell 384, a pulse waveform of the pulse laser beam outputted from the Pockels cell 384 may include: a first half portion having a small amount of polarization component parallel to the paper plane; and a second half portion having a large amount of polarization component parallel to the paper plane. Accordingly, in the first half portion of the pulse waveform, a small part of the pulse laser beam outputted from the master oscillator MO may be transmitted through the polarizer 386. In the second half portion of the pulse waveform, a large part of the pulse laser beam outputted from the master oscillator MO may be transmitted through the polarizer 386. Thus, a pulse laser beam outputted from the waveform controller 392 may include: a first stage having low light intensity; a second stage in which the light intensity increases steeply from the first stage to reach a peak value; and a third stage in which the light intensity decreases from the end of the second stage. The ratio R of the integral value Epd of the light intensity in the first stage to the integral value Eto of the light intensity of the whole pulse waveform including the first to third stages may be controlled by the voltage waveform generated by the high voltage power supply 383 as shown in FIG. 20C. The voltage waveform generated by the high voltage power supply 383 may be controlled by the delay time set by the delay circuit 381 and a voltage value generated by the voltage waveform generation circuit 382.

7.7 Variation of the Main Pulse Laser Apparatus (2)

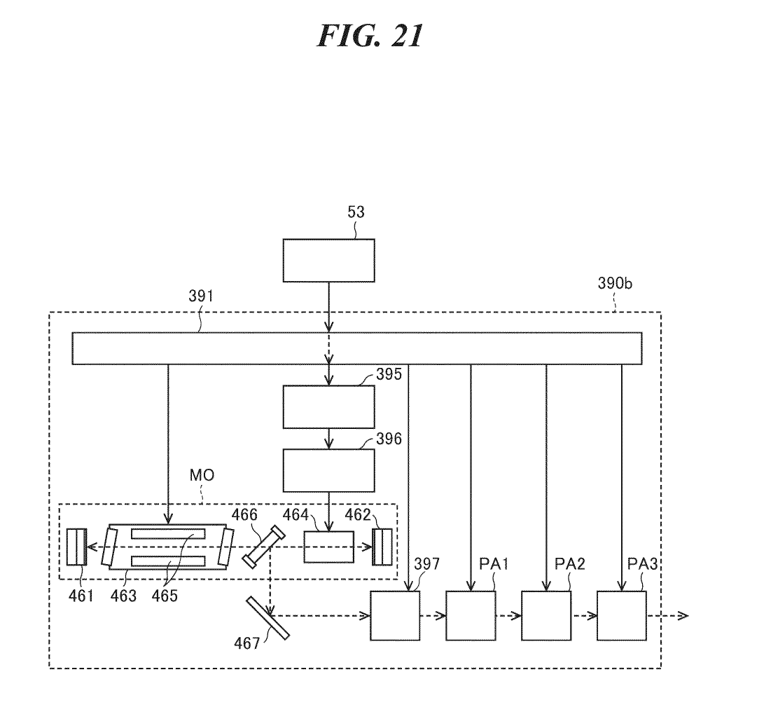

FIG. 21 schematically shows a configuration example of a main pulse laser apparatus 390b according to a seventh embodiment. The main pulse laser apparatus 390h according to the seventh embodiment may include, between the master oscillator MO and the amplifier PA1, a high reflection mirror 467 and a saturable absorber cell 397. Further, the main pulse laser apparatus 390b may include a voltage waveform generation circuit 395 and a high voltage power supply 396.

The master oscillator MO included in the main pulse laser apparatus 390b may include an optical resonator including high reflection mirrors 461 and 462. In the optical resonator, a laser chamber 463, a polarizer 466 and a Pockels cell 464 may be provided in this order from the side of the high reflection mirror 461. In the laser chamber 463, a pair of electrodes 465 may be disposed, and a CO₂ gas may be contained as a laser medium.

The master oscillator MO may excite the laser medium in the laser chamber 463 by electric discharge to be generated between the pair of electrodes 465. The laser beam may be amplified by travelling back and forth between the high reflection mirrors 461 and 462. The laser beam travelling back and forth between the high reflection mirrors 461 and 462 may be linearly polarized in a direction parallel to the paper plane. The polarizer 466 may transmit the laser beam linearly polarized in a direction parallel to the paper plane at high transmittance.

The high voltage power supply 396 may output pulse voltage based on the voltage waveform generated by the voltage waveform generation circuit 395. The pulse voltage may be applied to the Pockels cell 464. When the voltage is applied to the Pockels cell 464, the Pockels cell 464 may shift the phase of the second polarization component by ¼ wavelengths with respect to the phase of the first polarization component. In the laser beam transmitted through the Pockels cell 464 from the left side to the right side, reflected by the high reflection mirror 462 and transmitted again through the Pockels cell 464 from the right side to the left side, the phase of the second polarization component may be shifted by ½ wavelengths in total with respect to the phase of the first polarization component. Then, the laser beam may be incident on the polarizer 466 as a laser beam linearly polarized in a direction perpendicular to the paper plane. The polarizer 466 may reflect the laser beam linearly polarized in a direction perpendicular to the paper plane to output the laser beam from the master oscillator MO.

Here, as in the waveform of the pulse voltage as shown in FIG. 20C, the waveform of the pulse voltage applied to the Pockels cell 464 by the high voltage power supply 396 may have a relatively low voltage value at its first half portion and a relatively high voltage value at its second half portion. As a result, a waveform of the pulse laser beam outputted from the Pockels cell 464 may include: a first half portion having a small amount of polarization component perpendicular to the paper plane; and a second half portion having a large amount of polarization component perpendicular to the paper plane. Thus, a pulse laser beam outputted from the polarizer 466 may include: a first stage having low light intensity; a second stage in which the light intensity increases steeply from the first stage to reach a peak value; and a third stage in which the light intensity decreases from the end of the second stage. The ratio R of the integral value Epd of the light intensity in the first step to the integral value Eto of the light intensity of the whole pulse waveform including the first to third stages may be controlled by the voltage waveform as shown in FIG. 20C.

The high reflection mirror 467 may be disposed in an optical path of the pulse laser beam reflected by the polarizer 466. The high reflection mirror 467 may reflect the pulse laser beam at high reflectance toward the saturable absorber cell 397. The saturable absorber cell 397 may contain a saturable absorber gaseous material, for example. The saturable absorber may absorb the incident light while the intensity thereof is lower than a predetermined threshold value. When the intensity of the incident light increases up to the threshold value or more, the saturable absorber may transmit the incident light. The pulse laser beam reflected by the high reflection mirror 467 may pass through the saturable absorber cell 397. By passing through the saturable absorber cell 397, the ratio R in the waveform of the pulse laser beam may become lower. If the pressure or the concentration of the saturable absorber gaseous material inside the saturable absorber cell 397 is raised, or if the optical path length of the saturable absorber cell 397 is lengthened, the ratio R described above may further become lower. The other points may be substantially the same as that of the sixth embodiment described with reference to FIG. 19A.

7.8 Variation of the Main Pulse Laser Apparatus (3)

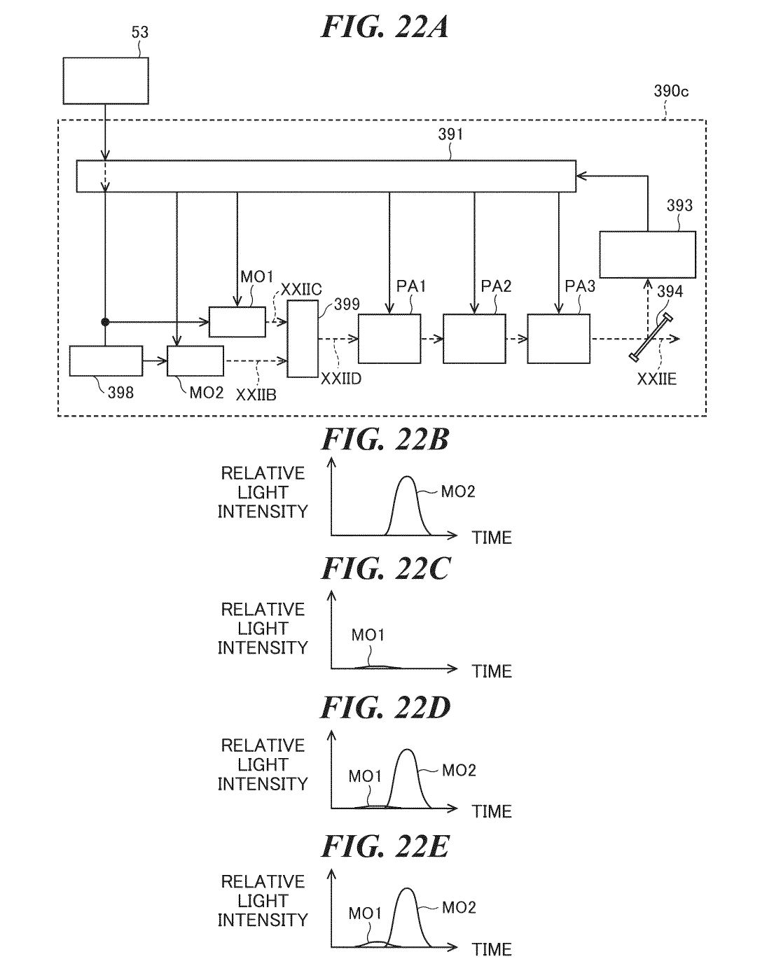

FIG. 22A schematically illustrates a configuration example of a main pulse laser apparatus 390c according to an eighth embodiment. The main pulse laser apparatus 390c in the eighth embodiment may include first and second master oscillators MO1 and MO2. Further, the main pulse laser apparatus 390c may include a delay circuit 398 and an optical path controller 399. The other points may be substantially the same as that of the sixth embodiment described with reference to FIG. 19A.

The first master oscillator MO1 may output a first pulse laser beam in synchronization with the timing signal from the delay circuit 53. The delay circuit 398 may output a signal which represents timing at which a predetermined delay time has passed from the timing of the timing signal outputted by the delay circuit 53. The second master oscillator MO2 may output the second pulse laser beam in synchronization with the signal outputted by the delay circuit 398. The optical path controller 399 may combine the optical paths of the pulse laser beams outputted from the first and second master oscillators MO1 and MO2 and output the pulse laser beams to the amplifier PA1. The optical path controller 399 may be constituted by a half mirror or a grating.

FIG. 22B is a graph showing a pulse waveform of the pulse laser beam outputted from the second master oscillator MO2 and indicated by a broken line XXIIB in FIG. 22A. FIG. 22C is a graph showing a pulse waveform of the pulse laser beam outputted from the first master oscillator MO1 and indicated by a broken line XXIIC in FIG. 22A. For purposes of simple illustration, the vertical axis in the graph of FIG. 22C is normalized by the peak value of the pulse laser beam shown in FIG. 22B. The pulse laser beam outputted from the first master oscillator MO1 may have lower peak intensity than the pulse laser beam outputted from the second master oscillator MO2. The pulse laser beam outputted from the second master oscillator MO2 may have a constant delay relative to the pulse laser beam outputted from the first master oscillator MO1.

FIG. 22D is a graph showing a pulse waveform of the pulse laser beam outputted from the optical path controller 399 and indicated by a broken line XXIID in FIG. 22A. FIG. 22E is a graph showing a pulse waveform of the pulse laser beam outputted from the main pulse laser apparatus 390c and indicated by a broken line XXIIE in FIG. 22A. By combining the optical paths of the pulse laser beams outputted from the first and second master oscillators MO1 and MO2, a pulse laser beam having a pulse waveform as shown in FIGS. 22D and 22E can be outputted. These pulse waveforms may include: a first stage having low light intensity; a second stage in which the light intensity increases steeply from the first stage to reach a peak value; and a third stage in which the light intensity decreases from the end of the second stage. The ratio R of the integral value Epd of the light intensity in the first step to the integral value Eto of the light intensity of the whole pulse waveform including the first to third stages may be controlled by the light intensity of the pulse laser beams outputted from the first and second master oscillators MO1 and MO2, respectively.

7.9 Variation of the Main Pulse Laser Apparatus (4)

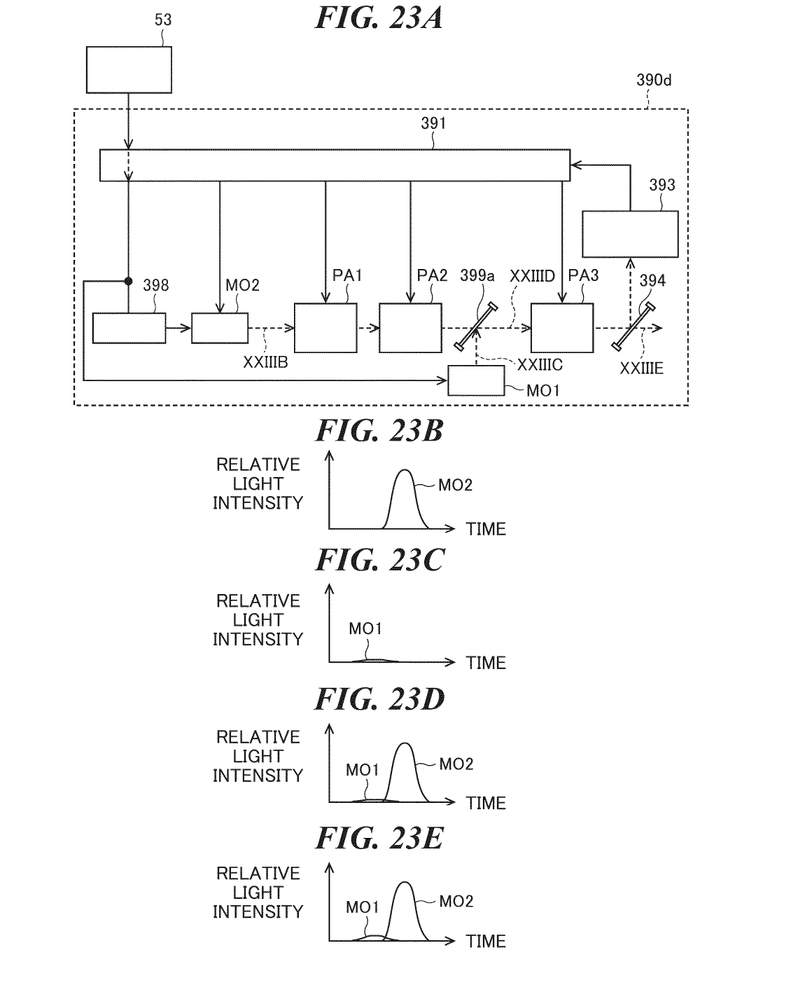

FIG. 23A schematically illustrates a configuration example of a main pulse laser apparatus 390d according to a ninth embodiment. FIG. 23B is a graph showing a pulse waveform of the pulse laser beam outputted from the second master oscillator MO2 and indicated by a broken line XXIIIB in FIG. 23A. FIG. 23C is a graph showing a pulse waveform of the pulse laser beam outputted from the first master oscillator MO1 and indicated by a broken line XXIIIC in FIG. 23A. FIG. 23D is a graph showing a pulse waveform of the pulse laser beam outputted from the optical path controller 399a and indicated by a broken line XXIIID in FIG. 23A. FIG. 23E is a graph showing a pulse waveform of the pulse laser beam outputted from the main pulse laser apparatus 390d and indicated by a broken line XXIIIE in FIG. 23A. Further, the vertical axis in the graph of FIG. 23C is normalized by the peak value of the pulse laser beam shown in FIG. 23B. In the main pulse laser apparatus 390d according to the ninth embodiment, the arrangement of the optical path controller 399a may be different from the arrangement of the optical path controller 399 in the eighth embodiment described with reference to FIG. 22A. The other points may be substantially the same as that of the eighth embodiment.

The pulse laser beam outputted from the second master oscillator MO2 may be directed directly to the amplifier PA1 without passing through the optical path controller. The optical path controller 399a may be disposed in an optical path between the amplifiers. The optical path controller 399a may be disposed in an optical path between the amplifier PA2 and the amplifier PA3. The optical path controller 399a may transmit the pulse laser beam amplified by the amplifiers PA1 and PA2 towards the amplifier PA3. The optical path controller 399a may reflect the pulse laser beam outputted from the first master oscillator MO1 to the amplifier PA3. Thus, the optical paths of the pulse laser beam outputted from the second master oscillator MO2 and the pulse laser beam outputted from the first master oscillator MO1 may be combined. For example, the wavelengths of the pulse laser beams outputted from the MO1 and MO2 may be 9.3 μm and 10.6 μm, respectively. In this case, the optical path controller 399a may be a dichroic mirror that reflects light having a wavelength of 9.3 μm at high reflectance and transmits light having a wavelength of 10.6 μm at high transmittance. As shown in FIG. 23E, the ninth embodiment can also output a pulse laser beam having a pulse waveform similar to that of the eighth embodiment. Also, in the ninth embodiment, one can control the ratio R by controlling the light intensities of the pulse laser beams outputted from the first and second master oscillators MO1 and MO2.

7.10 Light Intensity Distribution of the Main Pulse Laser Beam

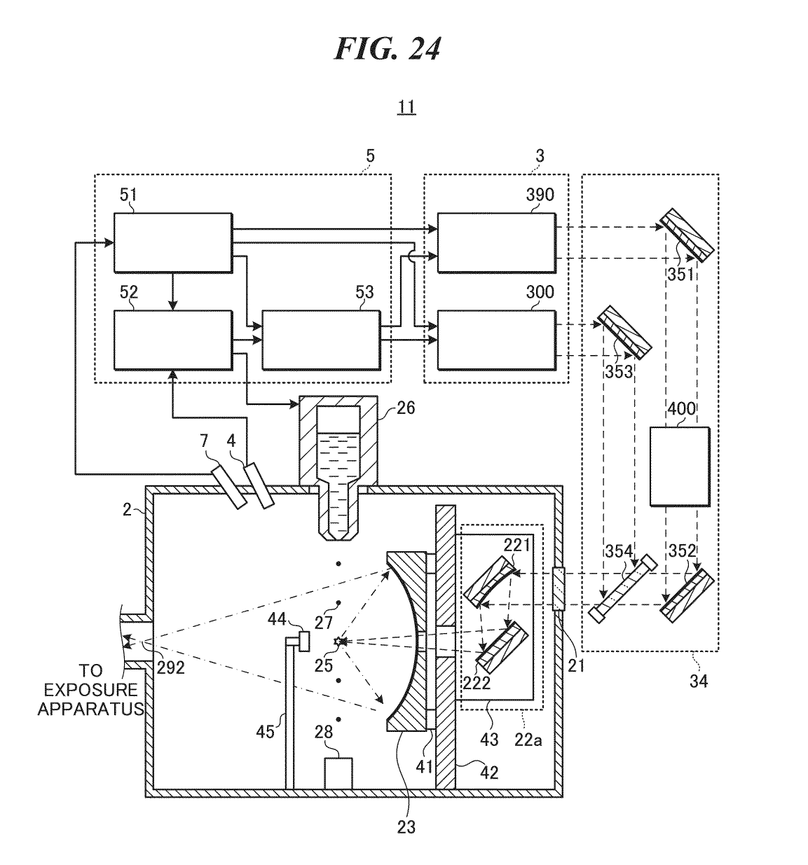

FIG. 24 is a partial cross-sectional view schematically showing a configuration example of the EUV light generation system 11 according to a tenth embodiment. In the tenth embodiment, a beam shaping optical system 400 for shaping light intensity distribution at the focal point of the main pulse laser beam may be disposed in the optical path of the main pulse laser beam outputted from the main pulse laser apparatus 390. The other points may be substantially the same as that of the first embodiment described with reference to FIG. 2.

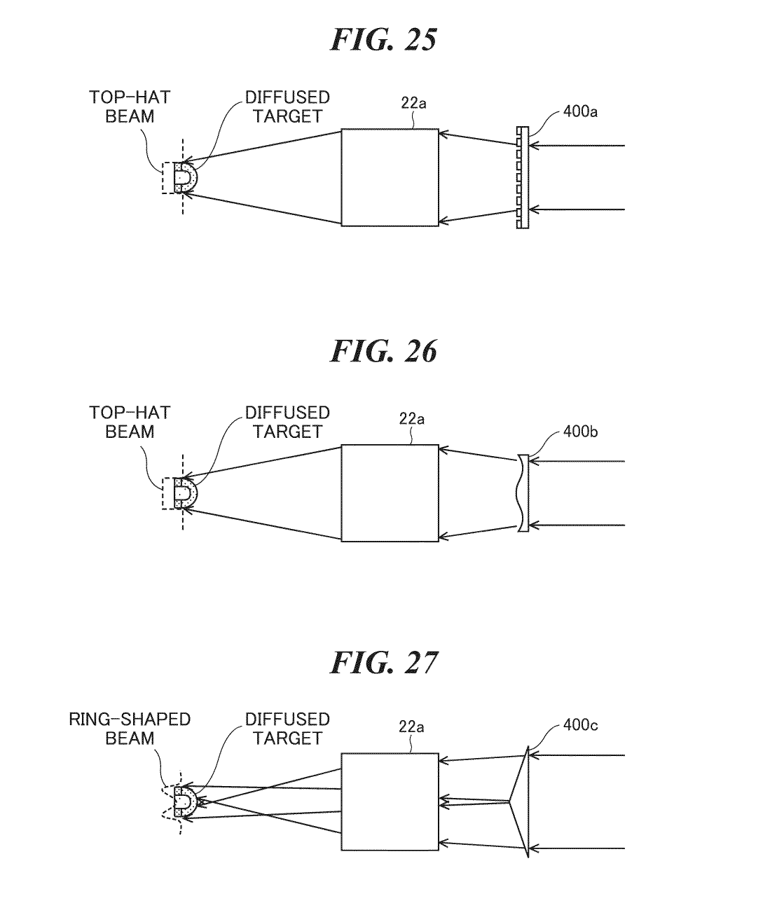

The beam shaping optical system 400 may be an optical system designed such that the cross section of the main pulse laser beam at the plasma generation region 25 has desired light intensity distribution. The plasma generation region 25 may correspond to the position of the diffused target at desired timing. Some specific configurations of the beam shaping optical system 400 will be described with reference to FIGS. 25 through 27.

FIG. 25 schematically illustrates a configuration example of the beam shaping optical system 400 shown in FIG. 24. The beam shaping optical system 400 may include a diffractive optical element 400a. The diffractive optical element 400a may be formed, for example, with a plate material, that is transparent for the wavelength of the main pulse laser beam, and on which minute concavities and convexities for diffracting the incident light are formed. The pattern of the concavities and convexities on the diffractive optical element 400a may be designed such that, when the diffracted light is focused by the focusing optics, the diffracted light forms a spot having substantially uniform light intensity distribution. The diffracted light outputted from the diffractive optical element 400a may be focused by the laser beam focusing optics 22a. Thus, the diffused target may be irradiated with the main pulse laser beam having top-hat light intensity distribution.

FIG. 26 schematically illustrates another configuration example of the beam shaping optical system 400 shown in FIG. 24. The beam shaping optical system 400 may include a phase shift optical system 400b. For example, the phase shift optical system 400b may be formed, for example, with a plate material, that is transparent for the wavelength of the main pulse laser beam, and which is thicker in the central portion than in the peripheral portion. The phase shift optical system 400b may give a phase difference π between light transmitted through the central portion and light transmitted through the peripheral portion. Thus, the incident light with Gaussian light intensity distribution may be converted into light having electric field intensity distribution similar to Airy function, and may be outputted from the phase shift optical system 400b.

Then, for example, the laser beam focusing optics 22a may be positioned such that a rear focal point of the laser beam focusing optics 22a matches the position of the diffused target, and the phase shift optical system 400b may be positioned on a front focal point of the laser beam focusing optics 22a. Thus, the diffused target may be irradiated with the main pulse laser beam having top-hat light intensity distribution generated by a Fourier transform of the Airy function. According to the inventors' study, a diffused target, generated by the pulse laser beam having a pulse duration of the picosecond order, is shaped as shown in FIG. 18A such that target density in the portion T1 is high. Therefore, by setting the light intensity distribution of the main pulse laser beam at the focal point to the top-hat shape, and by approximately conforming the focusing spot diameter to the diameter of the diffused target, CE can be improved.

FIG. 27 schematically illustrates another configuration example of the beam shaping optical system 400 shown in FIG. 24. The beam shaping optical system 400 may include an axicon lens 400c. The axicon lens 400c may be a conical lens and may be disposed such that its rotational axis substantially matches the travelling direction of the main pulse laser beam. A laser beam incident on the axicon lens 400c may be refracted at an angle regardless of the distance from the rotational axis and symmetrically with respect to the rotational symmetry axis, and emitted from the axicon lens 400c.

The main pulse laser beam emitted from the axicon lens 400c may be focused by the laser beam focusing optics 22a at the position of the focal length f from the main surface of the laser beam focusing optics 22a. The light intensity distribution at the position of the focal length can be ring-shaped distribution having low intensity region in the central portion. At the position of the focal length, the diffused target may be irradiated with the main pulse laser beam. According to the inventors' study, a diffused target, generated by the pulse laser beam having a pulse duration of the picosecond order, is shaped as shown in FIG. 18A such that target density in the portion T1 is high. Therefore, by setting the light intensity distribution of the main pulse laser beam at the focal point to the annular shape, and by approximately conforming the outer diameter of the annular shape to the diameter of the diffused target, CE can be improved.

The descriptions above are intended to be illustrative only and the present disclosure is not limited thereto. Therefore, it will be apparent to those skilled in the art that it is possible to make modifications to the embodiments of the present disclosure within the scope of the appended claims.

The terms used in this specification and the appended claims should be interpreted as “non-limiting.” For example, the terms “include” and “be included” should be interpreted as “including the stated elements but not limited to the stated elements.” The term “have” should be interpreted as “having the stated elements but not limited to the stated elements.” Further, the modifier “one (a/an)” should be interpreted as “at least one” or “one or more.”

1. A laser system comprising:
a clock generator configured to output a clock signal;
a mode-locked laser device having an optical resonator and configured to oscillate at a plurality of longitudinal modes with fixed phases with each other to output a pulse laser beam;
a controlling device capable of controlling resonator length of the optical resonator;
a detector disposed in an optical path of the pulse laser beam, configured to detect the pulse laser beam and output a detection signal;
a switching device disposed in the optical path of the pulse laser beam, capable of switching the pulse laser beam; and
a controller, capable of controlling the controlling device based on the clock signal outputted by the clock generator and on the detection signal outputted by the detector, and capable of controlling the switching device based on the clock signal outputted by the clock generator and on a timing signal outputted by an external device.

2. The laser system according to claim 1, wherein:
the switching device has a regenerative amplifier having a Pockels cell;
the Pockels cell is configured to change its optical properties based on a control signal outputted by the controller; and
the regenerative amplifier is configured, by changing the optical properties of the Pockels cell, to switch whether or not to amplify light intensity of the pulse laser beam to a predetermined value.

3. The laser system according to claim 1, wherein:
the switching device has an optical shutter; and
the optical shutter is configured to change its transmittance of the pulse laser beam based on a control signal outputted by the controller.

4. An extreme ultraviolet light generation system comprising:
a clock generator configured to output a clock signal;
a mode-locked laser device having an optical resonator and configured to oscillate at a plurality of longitudinal modes with fixed phases with each other to output a pulse laser beam;
a controlling device capable of controlling resonator length of the optical resonator;
a detector disposed in an optical path of the pulse laser beam, configured to detect the pulse laser beam and output a detection signal;
a switching device disposed in the optical path of the pulse laser beam, capable of switching the pulse laser beam;
a chamber disposed in downstream of the switching device in the optical path of the pulse laser beam, and having an entrance at a position where the pulse laser beam can enter into the chamber;
a target supply device disposed with the chamber, capable of supplying a target material to a predetermined region in the chamber, and capable of outputting a timing signal showing supply timing of the target material;
a laser beam focusing optics disposed between the switching device and the predetermined region in the optical path of the pulse laser beam, capable of focusing the pulse laser beam at the predetermined region; and
a controller, capable of controlling the controlling device based on the clock signal outputted by the clock generator and on the detection signal outputted by the detector, and capable of controlling the switching device based on the clock signal outputted by the clock generator and on the timing signal outputted by the target supply device.

5. The extreme ultraviolet light generation system according to claim 4, wherein:
the target supply device has a target detector for detecting the target material supplied into the chamber; and
the target detector is capable of outputting the timing signal.

6. A laser system comprising:
a clock generator configured to output a clock signal;
a frequency divider configured to output, based on the clock signal outputted by the clock generator, a timing signal having repetition rate which is lower than repetition rate of the clock signal;
a mode-locked laser device having an optical resonator and configured to oscillate at a plurality of longitudinal modes with fixed phases with each other to output a pulse laser beam;
a controlling device capable of controlling resonator length of the optical resonator;
a detector disposed in an optical path of the pulse laser beam, configured to detect the pulse laser beam and output a detection signal;
a switching device disposed in the optical path of the pulse laser beam, capable of switching the pulse laser beam; and
a controller, capable of controlling the controlling device based on the clock signal outputted by the clock generator and on the detection signal outputted by the detector, and capable of controlling the switching device based on the timing signal outputted by the frequency divider.

7. An extreme ultraviolet light generation system comprising:
a clock generator configured to output a clock signal;
a frequency divider configured to output, based on the clock signal outputted by the clock generator, a timing signal having repetition rate which is lower than repetition rate of the clock signal;
a mode-locked laser device having an optical resonator and configured to oscillate at a plurality of longitudinal modes with fixed phases with each other to output a pulse laser beam;
a controlling device capable of controlling resonator length of the optical resonator;
a detector disposed in an optical path of the pulse laser beam, configured to detect the pulse laser beam and output a detection signal;
a switching device disposed in the optical path of the pulse laser beam, capable of switching the pulse laser beam;
a chamber disposed in downstream of the switching device in the optical path of the pulse laser beam, and having an entrance at a position where the pulse laser beam can enter into the chamber;
a target supply device disposed with the chamber, capable of supplying a target material to a predetermined region in the chamber based on the timing signal outputted by the frequency divider;
a laser beam focusing optics disposed between the switching device and the predetermined region in the optical path of the pulse laser beam, capable of focusing the pulse laser beam at the predetermined region; and
a controller, capable of controlling the controlling device based on the clock signal outputted by the clock generator and on the detection signal outputted by the detector, and capable of controlling the switching device based on the timing signal outputted by the frequency divider.
